(19) United States
(12) Patent Application Publication
(10) Pub. No.: US 2024/0320743 A1
(43) Pub. Date: Sep. 26, 2024

(54) AUGMENTED REALITY AIDED ASSET MANAGEMENT

(71) Applicant: Rockwell Automation Technologies, Inc., Mayfield Heights, OH (US)

(72) Inventors: Sophia Gustafson, West Lafayette, IN (US); Benjamin Young, Waukesha, WI (US); Thong Nguyen, New Berlin, WI (US); Paul D. Schmirler, Glendale, WI (US); Timothy T. Duffy, Franklin, WI (US)

(21) Appl. No.: 18/189,343

(22) Filed: Mar. 24, 2023

(51) Int. Cl. G06Q 40/06

(52) U.S. Cl. CPC G06Q 40/06

(57) ABSTRACT

An industrial asset management system leverages augmented reality (AR) technology to discover and register assets within an industrial facility. The system uses the registered asset tracking information in conjunction with AR-based navigational features to guide users to desired assets and to provide information about an asset within the user's field of view. The asset management system also supports AR-assisted asset check in and check out workflows.

### TECHNICAL FIELD

The subject matter disclosed herein relates generally to industrial automation systems, and, more particularly, to tracking and management of industrial assets.

### BACKGROUND ART

An industrial facility that manufactures products or materials typically maintains a wide assortment of assets, tools, and devices that are required to maintain and operate the automation systems in service at the facility, as well as to perform business-level functions such as accounting, sales, human resources, and other such functions. Since an industrial enterprise encompasses both business-level functions as well as operating technology (OT) functions associated with installation, maintenance, and operation of industrial equipment, the number and scope of assets that must be maintained and tracked within an industrial facility are considerably greater than in a conventional office environment. Formal systems for tracking and managing these various assets can aid in maximizing their utility and improving their accessibility.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system is provided, comprising a client interface component configured to receive, from an augmented reality (AR) client device within a plant facility, visual data representing shapes of objects within a field of view of the AR client device, and location and orientation data indicating a current location and orientation of the AR client device; an asset identification component configured to identify an asset within the field of view of the AR client device based on analysis of the visual data; and an asset registration component configured to, in response to identification of the asset by the asset identification component, create or update an asset record for the asset based on the identification of the asset, wherein the asset record records an identity of the asset and a location of the asset based on the location and orientation data.

Also, in one or more embodiments a method is provided, comprising receiving, by a system comprising a processor from an augmented reality (AR) client device, visual data representing an area surrounding the AR client device and location and orientation data representing a current location and orientation of the AR client device within an industrial facility; identifying, by the system based on analysis of the visual data, an asset within the area surrounding the AR client device; and in response to the identifying, generating or updating an asset record for the asset, wherein the asset record comprises information about the asset determined based on the analysis of the visual data and the location and orientation data, and the information comprises at least an identity of the asset and a location of the asset within the industrial facility.

Also, according to one or more embodiments, a non-transitory computer-readable medium is provided having stored thereon instructions that, in response to execution, cause a system to perform operations, the operations, comprising receiving, from an augmented reality (AR) client device, spatial mesh data generated by the AR client device based on a scan of an area surrounding the AR client device, and location and orientation data representing a current location and orientation of the AR client device within a plant facility; identifying, by the system based on analysis of the spatial mesh data, an asset within the area surrounding the AR client device; and in response to the identifying, creating or updating an asset record comprising information about the asset determined based on the analysis of the spatial mesh data and the location and orientation data, wherein the information about the asset comprises at least an identity of the asset and a location of the asset within the plant facility.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example augmented reality (AR) assisted industrial asset management system.

FIG. 2 is a block diagram of an example wearable appliance.

FIG. 3 is a diagram illustrating high-level, generalized data flows associated with collection and updating of asset records, or asset inventory data, using an AR device such as wearable appliance.

FIG. 4 is a diagram illustrating high-level, generalized data flows supported by an asset management system for providing asset information and guidance to a user via wearable appliance.

FIG. 5 is a diagram illustrating generation of asset records by the asset management system using data provided by an AR-capable wearable appliance.

FIG. 6 is a diagram illustrating generation of an asset record for a discovered asset based on AR-assisted data received from a wearable appliance.

FIG. 7 is a diagram illustrating creation and management of asset records based on scanned data received from multiple wearable AR appliances.

FIG. 8 is a diagram illustrating generation and delivery of AR presentations by an asset management system.

FIG. 9 is a set of example arrow graphics that can be rendered on a user's wearable appliance in connection with guiding the user along a route to an asset of interest.

FIG. 10 is an example portion of an AR presentation that can be rendered on a wearable appliance in a scenario in which a user is standing outside of a room in which an asset of interest is located.

FIG. 11 is an example portion of an AR presentation that can be rendered on the wearable appliance after the user has entered the room in which the asset resides.

FIG. 12 is an example portion of an AR presentation displaying an example informatics view of an asset that can be rendered on a wearable appliance.

FIG. 13 is an example portion of an AR presentation that renders color-coded asset category indicators designed to assist with location and organization of assets.

FIG. 14 is a diagram illustrating generation of P&ID drawings for an industrial facility based on information extracted from the asset records generated using AR-assisted information.

FIG. 15 is a flowchart of an example methodology for registering or updating an asset record for an industrial or office asset using AR-assisted techniques.

FIG. 16a is a flowchart of a first part of an example methodology for using augmented reality to guide a user to a desired asset within an industrial facility.

FIG. 16b is a flowchart of a second part of the example methodology for using augmented reality to guide a user to a desired asset within an industrial facility

FIG. 17 is a flowchart of an example methodology for conveying asset classifications via an AR presentation to assist with asset location and organization.

FIG. 18 is an example computing environment.

FIG. 19 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

An industrial facility that manufactures products or materials typically maintains a wide assortment of assets, tools, and devices that are required to maintain and operate the automation systems in service at the facility, as well as to perform business-level functions such as accounting, sales, human resources, and other such functions. Since an industrial enterprise encompasses both business-level functions as well as operating technology (OT) functions associated with installation, maintenance, and operation of industrial equipment, the number and scope of assets that must be maintained and tracked within an industrial facility are considerably greater than a conventional office environment.

Formal systems for tracking and managing these various assets can aid in maximizing their utility and improving their accessibility. Such systems can be used to track the identities, quantities, and locations of each type of asset, device, or part. However, asset management solutions that rely heavily on manual updating of an asset's status-such as the asset's identity, current location, update status, or inventory count—can be cumbersome and require continuous manual updating to ensure accurate tracking. Such systems are also prone to human error since there are multiple data entry points that could be incorrectly inputted. The laborious data entry workflow of such systems can also discourage users from consistently updating asset statuses, resulting in a loss of tracking accuracy due to lost or outdated information.

To address these and other issues, one or more embodiments of the present disclosure provide an industrial asset management system that leverages augmented reality (AR), virtual reality (VR), or mixed realty (MR) technology to discover assets and to maintain accurate records of their statuses and locations. The system can also use the collected asset tracking information in conjunction with AR-based navigational features to guide users to desired assets and to provide information about an asset within the user's field of view or otherwise within a defined proximity of the user (including objects obscured by walls or other obstructions that are positioned between the user and the asset).

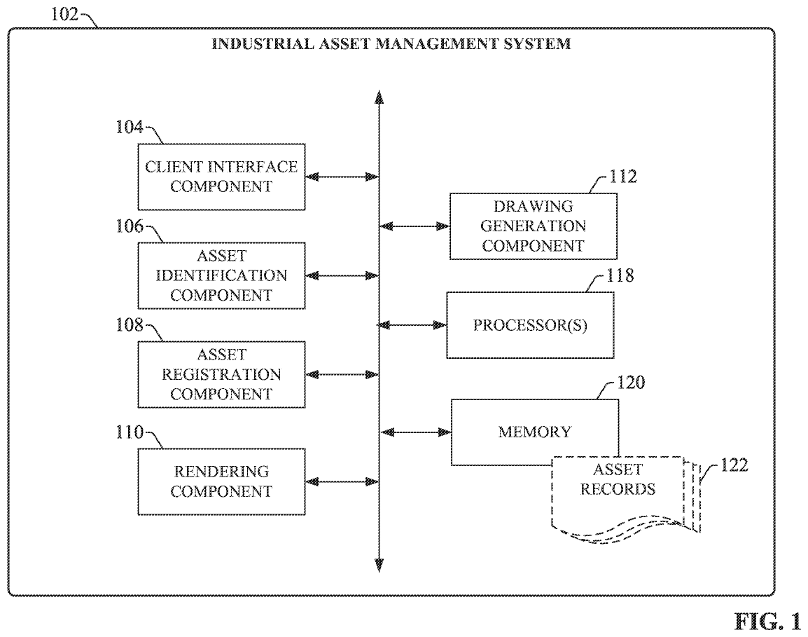

FIG. 1 is a block diagram of an example AR-assisted industrial asset management system 102 according to one or more embodiments of this disclosure. Although examples described and illustrated herein focus on the use of augmented reality in connection with asset registration, tracking, and management, the techniques described herein can also be used within the context of virtual reality or mixed reality technologies without departing from the scope of one or more embodiments. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial asset management system 102 can include a client interface component 104, an asset identification component 106, an asset registration component 108, a rendering component 110, a drawing generation component 112, one or more processors 118, and memory 120. In various embodiments, one or more of the client interface component 104, asset identification component 106, asset registration component 108, rendering component 110, drawing generation component 112, the one or more processors 118, and memory 120 can be electrically and/or communicatively coupled to one another to perform one or more of the functions of the asset management system 102. In some embodiments, components 104, 106, 108, 110, and 112 can comprise software instructions stored on memory 120 and executed by processor(s) 118. Asset management system 102 may also interact with other hardware and/or software components not depicted in FIG. 1. For example, processor(s) 118 may interact with one or more external user interface devices, such as a keyboard, a mouse, a display monitor, a touchscreen, a microphone, a sensor, an inertial measurement unit, or other such interface devices.

Client interface component 104 can be configured to exchange information between the asset management system 102 and a wearable AR appliance or other type of AR device having authorization to access the system 102. For example, the client interface component 104 can receive contextual information about a user based on a monitoring of the user's wearable appliance or other client device, visual information collected from the user's surroundings by the wearable appliance, smart data collected from an industrial asset by the wearable appliance, requests to check in or check out a specified asset, speech data submitted via the wearable appliance, or other such information. Client interface component 104 can also deliver augmented reality presentations to the wearable appliance or other AR device. These augmented reality presentations can include superimposed information about an asset within the user's field of view, navigational text and graphics that guide the user to a desired asset, asset check in and check out controls, auditory or haptic feedback, or other such information.

Asset identification component 106 can be configured to identify an asset based on information about the asset provided by the wearable appliance. This information can include, but is not limited to, visual data representing the user's environment (e.g., spatial mesh data, video or photographic data, etc.), smart data collected from the asset by the wearable appliance, optical character recognition (OCR) data collected from the asset (e.g. nameplate information), or other such data.

Asset registration component 108 can be configured to generate and store information about a discovered asset as an asset record 122. This asset record 122 can include such information as an identity or type of the asset, an asset classification (e.g., electronics, mechanical, office supplies, etc.), a current location, a home location, a status of the asset, an identity of a person who is currently in possession of or responsible for the asset, or other such information.

Rendering component 110 can be configured to generate an AR presentation for rendering on a user's wearable appliance or other AR device by the client interface component 104. The AR presentation is a function of a current asset management interaction being performed by the user, and can include, but is not limited to, navigational overlays that guide the user to an asset of interest, information about an asset within the user's field of view, interactive control overlays, or other such AR presentations. Drawing generation component 112 can be configured to generate engineering drawings, such as piping and instrumentation diagrams, based on information contained in the asset records 122.

The one or more processors 118 can perform one or more of the functions described herein with reference to the systems and/or methods disclosed. Memory 120 can be a computer-readable storage medium storing computer-executable instructions and/or information for performing the functions described herein with reference to the systems and/or methods disclosed.

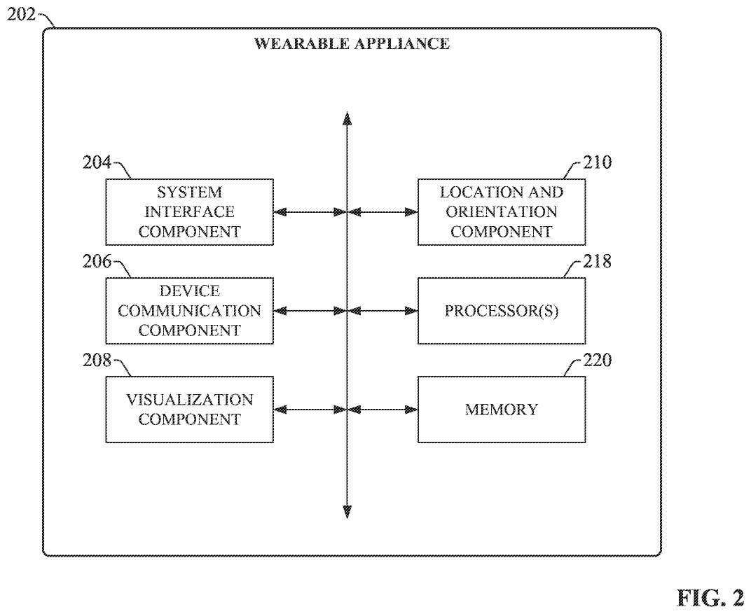

FIG. 2 is a block diagram of an example wearable appliance 202 according to one or more embodiments of this disclosure. Wearable appliance 202 can be, for example, an augmented reality headset worn on a user's head and comprising a transparent or semitransparent viewing lens or screen through which the user views his or her surroundings, where the appliance 202 can render graphical or alphanumeric information at selected locations on the lens or screen, thereby overlaying information onto the user's field of view. The appliance 202 can also include other types of integrated sensors for collecting information about a user's surroundings, and can support delivery of one or more types of user feedback (e.g., visual, audible, haptic, etc.). In general, wearable appliance 202 can comprise any suitable wearable or portable computing device or appliance capable of rendering an augmented reality presentation that substantially surrounds the user's field of view. As will be described in more detail herein, user interactions with the AR presentations are facilitated by data exchange between a user's wearable appliance 202 and the asset management system 102, which acts as a content provider for the appliance 202. Wearable appliance 202 can include a system interface component 204, a device communication component 206, a visualization component 208, a location and orientation component 210, one or more processors 218, and memory 220. In various embodiments, one or more of the system interface component 204, device communication component 206, visualization component 208, location and orientation component 210, the one or more processors 218, and memory 220 can be electrically and/or communicatively coupled to one another to perform one or more of the functions of the wearable appliance 202. In some embodiments, components 204, 206, 208, and 210 can comprise software instructions stored on memory 220 and executed by processor(s) 218. Wearable appliance 202 may also interact with other hardware and/or software components not depicted in FIG. 2. For example, processor(s) 218 may interact with one or more external user interface devices, such as a keyboard, a mouse, a display monitor, a touchscreen, or other such interface devices.

System interface component 204 can be configured to exchange data over wireless communication channels or networks with asset management system 102. Device communication component 206 can be configured to exchange data between the wearable appliance 202 and industrial devices via any suitable connection channels, including a wireless connection, an industrial network on which the devices reside, or other such channels. In an example implementation for use with CIP networks, the device communication component 206 can support CIP protocol carried by EtherNet/IP. However, embodiments described herein are not limited to these protocols.

Visualization component 208 can be configured to render the AR presentations delivered to the wearable appliance 202 by the asset management system 102. In some embodiments, the visualization component 208 or other components of the wearable appliance 202 can support other types of feedback or signaling directed to the wearer, including but not limited to audio or haptic feedback.

Location and orientation component 210 can be configured to determine and report a location and an orientation of the wearable appliance 202. This location and orientation information can be sent to the asset management system 102 by system interface component 204 so that wearer's location and field of view can be determined, and so that the AR presentation rendered by visualization component 208 is adapted to the user's current location and orientation. The user's location information can also be used by the asset management system 102 to register a current location of an asset discovered by the wearable appliance 202.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

Although the example systems and methods described herein assume that an AR-capable wearable appliance 202 serves as the client device for the industrial asset management system 102, other types of AR-capable devices, including non-wearable or hand-held client devices, can also serve as clients for the asset management system 102. Such AR-capable devices can perform functions similar to those of the wearable appliance 202 described herein.

In some embodiments, asset management system 102 can reside on a server or other high-level platform within the industrial facility or at a remote location, and can remotely exchange data with wearable appliances 202 via one or more intervening networks. Alternatively, asset management system 102 execute as a set of cloud services on a cloud platform or another web-based platform that is accessible to the wearable appliances 202

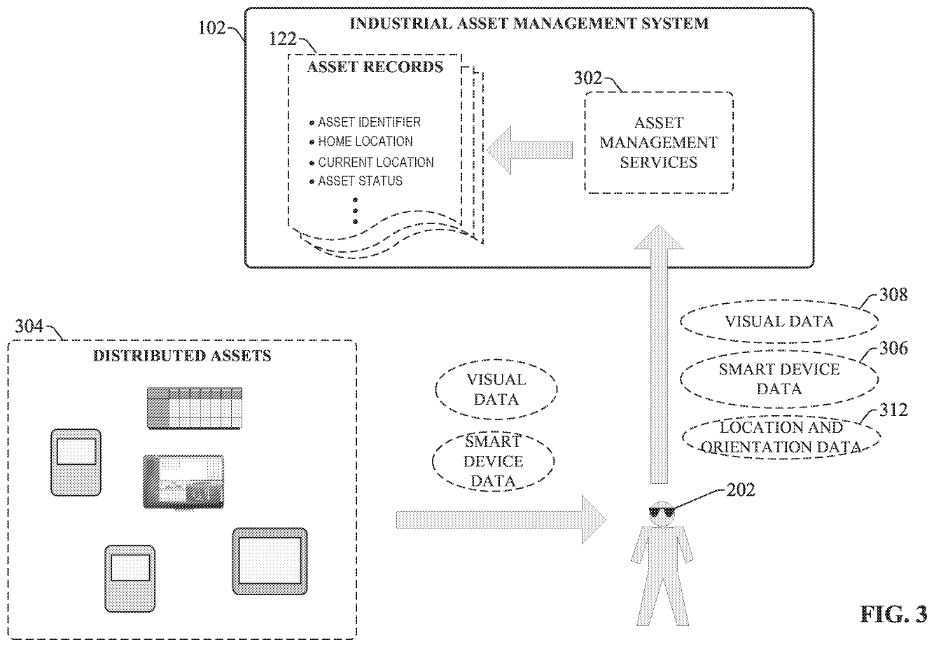

FIG. 3 is a diagram illustrating high-level, generalized data flows associated with collection and updating of asset records 122, or asset inventory data, using an AR device such as wearable appliance 202. An industrial facility or enterprise can house a large number of various types of assets 304, including industrial devices and associated parts or equipment (e.g., industrial controllers, I/O modules, motor drives, contactors, human-machine interface terminals, etc.); mechanical components, tools, or parts used in the facility's automation systems; maintenance tools; office supplies (e.g., computers and laptops); and other such assets. These assets 304 are typically distributed throughout a facility and are either in-service or stored at a designated location.

Asset management system 102, working in conjunction with wearable appliance 202 or another type of AR client device, can at least partially automate the process of registering the identities and locations these various assets 304 as well as recording the statuses of these assets 304 on an ongoing basis. In general, the wearable appliance 202 collects information about assets 304 within a visual or communication range of the appliance 202 and provides this asset information to the asset management system 102. Based on this collected asset information, asset management services 302 executed by the system 102 (to be described in more detail herein) generates and stores asset records 122 that record the identities, statuses, and locations of the assets 304.

The system 102 can leverage a variety of types of information collected and provided by the wearable appliance 202, including visual data 308 (e.g., spatial mesh data, optical data, video or photographic data, etc.) representing shapes of objects and surfaces within the user's field of view as well as smart device data 306 read from smart devices by the wearable appliance 202. The wearable appliance 202 can send this information to the asset management system 102 together with other types of information, including location and orientation data 312 representing the current location and orientation of the wearable appliance 202, speech information submitted by the wearer of wearable appliance 202, an identifier of the wearer, wearer gesture information, or other such information. The system 102 uses this information to create or update asset records 122, which are recorded on storage associated with the system 102 (e.g., cloud-based storage or local memory of the hardware platform on which the system 102 operates).

An asset record 122 for a given asset can record such information as an identifier for the asset, a type or classification of the asset, a home location to which the asset is designated (e.g., a storage room or area, a shelf, a drawer, a toolbox, etc.), a current location of the asset, status information for the asset (e.g., checked in and checked out status, memory or processing capability, software status, etc.), or other such information.

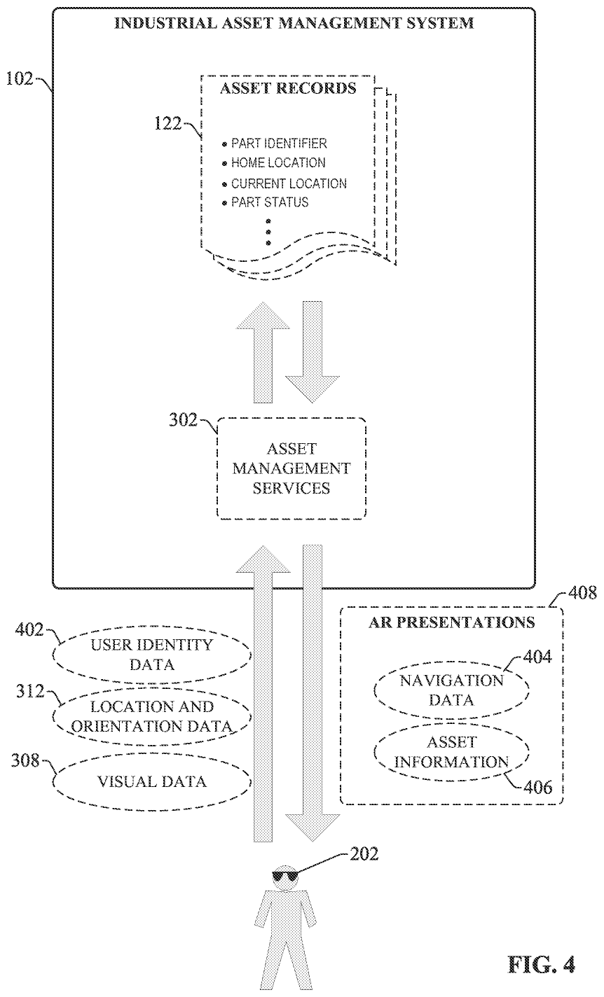

FIG. 4 is a diagram illustrating high-level, generalized data flows supported by the asset management system 102 for providing asset information and guidance to a user via wearable appliance 202. In general, the asset management services 302 can leverage the asset records 122 generated as described above to dynamically provide information 406 about an asset 304 within the user's field of view as an AR presentation 408 rendered on the wearable appliance 202. As will be described in more detail herein, data used to populate the AR presentations 408 can be obtained from the asset records 122 as well as other relevant data sources, such as plant map data, vendor websites or databases, or other such data sources. The asset management system 102 can customize the AR presentation 408—in terms of the information presented as well as its formatting and location within the user's field of view-based on the user's current context, line of sight, the type of AR device being used (e.g., wearable appliance 202 or another AR-capable device), or other relevant information.

As will be described in more detail below, the content of an AR presentation 408 rendered on the wearable appliance 202 is based on a variety of data submitted to the system 102 by the wearable appliance 202, including visual data 308 representing shapes of objects and surfaces within the user's surroundings, location and orientation data 312 representing a current location and orientation of the wearable appliance 202, user identity data 402 identifying the user or the user's role, or other such information. The location and orientation component 210 of wearable appliance 202 can be configured to determine a current geographical location of the appliance 202. In some embodiments, location and orientation component 210 can leverage global positioning system (GPS) technology to determine the user's absolute location, or may be configured to exchange data with positioning sensors located within the plant facility in order to determine the user's relative location within the plant. Location and orientation component 210 can also include orientation sensing components that measure the wearable appliance's current orientation in terms of the direction of the appliance's line of site, the angle of the appliance relative to horizontal, etc. Other types of sensors or algorithms can be supported by embodiments of the wearable appliance 202 for determining a wearer's current location and orientation, including but not limited to inertial measurement units (IMUs) or visual-inertial odometry (VIO). The wearable appliance's system interface component 204 can report the location and orientation information generated by location and orientation component 210 to the asset management system 102 as location and orientation data 312.

In addition to generating AR presentations 408 that deliver information about assets 304 currently within the user's field of view, asset management system 102 can also generate and deliver AR presentations 408 comprising navigation data 404 that guides the user to a desired asset given the asset's current location, as determined from the asset records 122, and the user's current location and orientation as obtained from location and orientation data 312. Navigation data 404 can comprise visual cues that are rendered on the wearable appliance's lens or screen over the user's field of view, as well as audio or haptic cues that are configured to guide or navigate the user to an asset of interest.

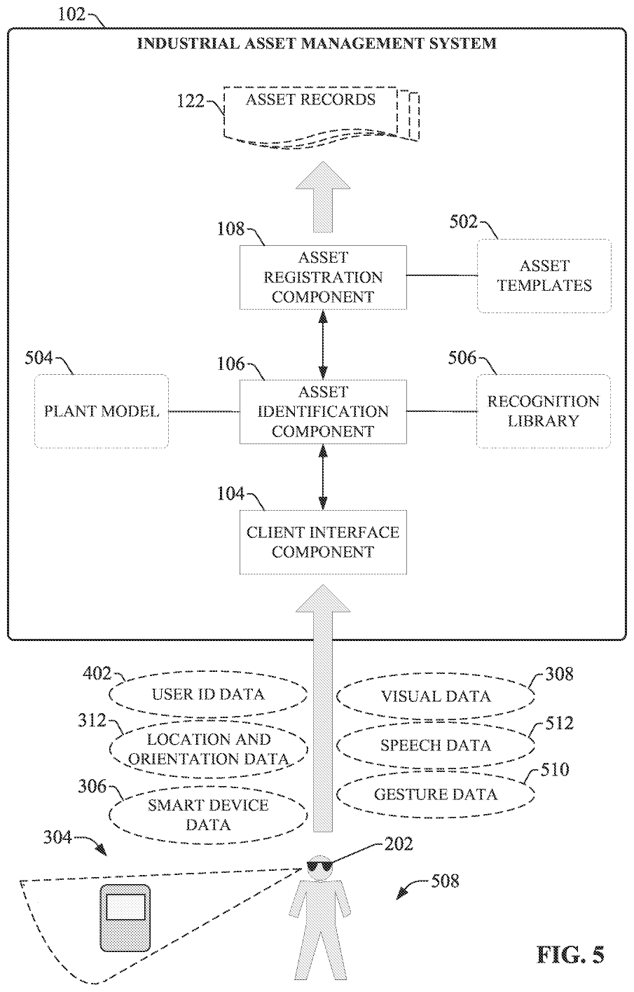

FIG. 5 is a diagram illustrating generation of asset records 122 by the asset management system 102 using data provided by an AR-capable wearable appliance 202 in more detail. In general, industrial asset management system uses augmented reality capabilities to simplify and substantially automate the asset management workflow, as well as to reduce the potential for inaccurately logged asset information due to human error.

In the context of the present disclosure, an asset can refer to an industrial component or device (including electrical, mechanical, or computerized assets), tools or equipment used by maintenance staff in either the operational technology (OT) environment or the information technology (IT) environment, spare parts, materials, industrial machines, or other such assets. The system can generate and maintain asset records 122 for respective different assets or asset types. Example information that can be included in a given asset record 122 can include, but is not limited to, an identifier of the asset, a type of the asset, a classification for the asset (e.g., mechanical, electrical, office, plant floor, etc.), an asset description, a home location for the asset (that is, the location at which the asset should reside when not checked out by an authorized staff member), a current location of the asset, status information for the asset (e.g., checked in, checked out, firmware update required, low power, etc.), an indication of whether a software or hardware feature of the asset requires an update (e.g., an update of the asset's software or firmware, replacement of an expired part, etc.), a number of units of the asset currently in stock, or other such information. The content and format of the data logged for an asset can depend on the asset type, as well as whether the asset is a fixed (e.g., a stationary machine) or mobile (e.g., a tool used by maintenance staff).

The wearable appliance 202 can be worn by a user 508 within the plant facility and can collect or generate various types of data for submission to the asset management system 102, including but not limited to user identity data 402 identifying the user 508 or the user's role, location and orientation data 312 representing the current location and orientation of the wearable appliance 202, visual data 308 generated by the wearable appliance 202 based on a scanning of the user's surroundings, speech data 512 representing spoken information recorded and sent by the wearable appliance 202, gesture data 510 representing recorded gestures made by the user 508 and monitored by the wearable appliance 202, smart device data 306 read from a device's memory, optical code information scanned from a barcode or QR code on the device, or other such information. In general, substantially any type of information that can be collected by the wearable appliance's integrated sensors can be leveraged by the asset management system 102 in connection with identifying and registering an asset, as well as maintaining current records of the asset's location and status.

Visual data 308 can comprise substantially any type of data representing shapes, objects, surfaces, or contours of the user's surroundings, generated based on a scanning of the user's environment by the wearable appliance 202. For example, in some embodiments the visual data 308 three-dimensional (3D) modeling data, such as spatial mesh or 3D mesh data, representing shapes and contours of objects and surfaces within the user's surroundings. Visual data 308 may also comprise time-of-flight or point cloud data representing an array of distances between the wearable appliance 202 and points within the user's surroundings or field of view. In still other examples, visual data 308 can include photographic or video data recorded by the wearable appliance 202. Other types of visual data 308 are also within the scope of one or more embodiments.

Some embodiments of asset management system 102 can include an asset identification component 106 configured to recognize or identify an asset 304 scanned by the wearable appliance 202 based on analysis of the visual data 308 received from the wearable appliance 202. Various types of asset recognition processing can be performed by the asset identification component 106 depending on the type of visual data 308 being processed. For example, in the case of visual data 308 comprising spatial mesh data or other types of 3D modeling information, the asset identification component 106 can apply shape recognition analysis to identify asset types based on their shapes, as obtained based on analysis of the spatial mesh data. In some embodiments the asset identification component 106 can identify assets 304 represented in the visual data 308 by cross-referencing shapes discovered in the visual data 308 with information in a recognition library 506 associated with the system 102. The recognition library 506 can comprise information defining, for respective different asset types, 3D shapes that are known to correlate with those asset types. When visual data 308 comprising spatial mesh information is received at the system 102 from a wearable appliance 202, the asset identification component 106 can determine whether any of the object shapes contained in the spatial mesh information correspond to a 3D shape defined in the recognition library 506. If a recognized shape is discovered in the visual data 308 based on this cross-referencing, the asset identification component 106 can determine the type of asset corresponding to the shape based on the information defined for the shape in the recognition library 506. Example asset types that can be recognized in this manner include, but are not limited to, categories of tools or maintenance equipment, industrial machines or devices as well as their associated spare parts (e.g., drill bits or other machining tools, industrial controllers, I/O modules, motor drives such as variable frequency drives), office equipment (e.g., laptop or desktop computers, office furniture), or other such asset types.

In some cases, an asset 304 may be labeled or marked with an optical code, such as a barcode or a QR code, that encodes information about the asset, such as the asset's model number, vendor, asset type, or other such information. In such scenarios, the wearable appliance 202 can scan this optical code to obtain the encoded asset information and send this information to the asset management system 102 (e.g., as part of visual data 308). Asset identification component 106 can translate this optical code information into registerable information about the asset 304 that can be stored as part of the corresponding asset record 122.

Some assets 304, such as smart industrial devices, may also store self-identifying information—or smart device data 306—on local readable memory that can be wirelessly accessed and read by the wearable appliance 202. Some smart devices can automatically update their stored smart device data 306 to reflect their current states, software, or capabilities. To register such devices, the wearable appliance 202 can query the asset 304 via a wireless channel for any smart device data 306 that may be stored locally on the asset 304, retrieve the stored smart device data 306 via the channel if present, and relay the data 306 to the asset management system 102 via the system's client interface component 104. Any suitable type of wireless link between wearable appliance 202 and the smart device can be used to query for and retrieve the device's data 306.

The content of smart device data 306 can depend on the type and vendor of the asset 304, and may include a model or serial number for the asset 304, a vendor identifier, a type of the asset 304 (e.g., industrial controller, an I/O module of a specific type, a variable frequency drive, a desktop computer, etc.), specification information for the asset 308 (e.g., nameplate information, power supply information, supported functions of the asset, available memory or processing capacities, etc.), software installed on the asset, a firmware version installed on the asset, or other such information. Smart device data 306, if available, can eliminate the need to infer the identity of an asset 304 based on shape recognition, as well as provide more detailed specification information for the asset 304. Other sources of asset information can also be accessed or interpreted by the wearable appliance 202 and provided to the asset management system 102 in various embodiments.

Asset registration component 108 can generate asset records 122 based on analysis of one or more of the visual data 308 and smart device data 306, as well as other contextual data provided by the wearable appliance 202. For newly discovered assets 304 that have not yet registered with the system 102, the asset registration component 108 can generate a new asset record 122 for the new asset 304 and populate the record 122 with information about the new asset 304, as obtained based on the data submitted by the wearable appliance 202 and analysis of that data by the asset identification component 106. The content of the data contained in an asset's data record can depend on the type of asset. Some embodiments of asset registration component 108 can format data records for respective assets 304 based on asset templates 502, which define the data fields that make up the data record. These asset templates 502, which define the structure of an asset record 122 in terms of the data fields that are to be populated with respective items of data about the asset, can be predefined and stored in association with the asset management system 102 for reference by the asset registration component 108. The system 102 can store multiple predefined asset templates 502 corresponding to respective different asset types, which may require different sets of information to accurately record the assets' identities and statuses. Example data fields defined by an asset template 502 can include, but are not limited to, an asset name, an asset description, a category or classification to which the asset belongs, a status of the asset, a home location for the asset, a current location for the asset, the asset's condition, a part number, a number of items of the asset 304 that are currently in inventory, a minimum number of units that should be maintained, or other such data items.

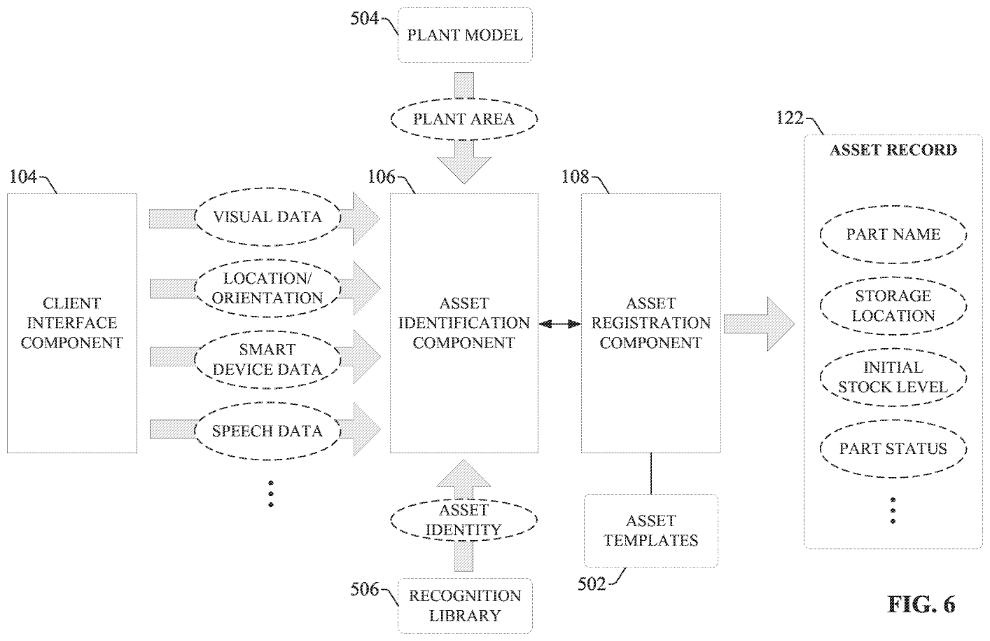

The asset registration component 108 can automatically populate the fields of the appropriate asset template 502 for a newly discovered asset 304 using information collected and provided by the wearable appliance 202. FIG. 6 is a diagram illustrating generation of an asset record 122 for a discovered asset 304 based on AR-assisted data received from the wearable appliance 202 according to one or more embodiments. As described above, the system's client interface component 104 can receive one or more types of visual data 308 from the wearable appliance 202, or smart device data 306 retrieved from the asset 304 if applicable. Based on this data, the asset identification component 106 can identify the asset 304, or a type of the asset, using any suitable technique including those described above. For example, in the case of spatial mesh data, the asset identification component 106 can identify shapes within the spatial mesh that are known to correspond to specific types of assets (as defined in the recognition library 506, or by other shape-recognition means). The asset registration component 108 can record the asset type corresponding to the discovered shape in the asset record 122 for that asset.

If other information about the asset 304 can be inferred based on the discovered asset type, the asset registration component 108 can also add this information to the asset record 122. This additional information can include, for example, a description of the asset 304, the asset's vendor, a classification for the asset (e.g., electrical, mechanical, office, etc.), a home location for the asset 304 (that is, the location in which the asset 304 should be stored when not checked out for use), or other such information that is specific to the asset type or classification inferred by the shape-recognition analysis. If a newly discovered asset 304 is inferred to belong to an asset type or classification for which a designated storage location has been defined, the client interface component 104 can render, on the wearable appliance 202, an indication of the recommended storage location for the asset 304 as part of the asset registration process. This can be particularly useful in scenarios in which a user has found a misplaced tool or other type of asset—or has received shipment of a new asset—and is not aware of the asset's correct storage location. The user can scan the new or misplaced asset with his or her wearable appliance 202 to both register the asset and learn its correct home location. To determine the home location for a given asset type, the asset identification component 106 can cross-reference the asset's inferred type or classification with a data set that defines the home locations for respective different asset types.

In the case of smart device data 306, which contains explicit information about the asset 304, the asset registration component 108 can map selected items of the smart device data 306 to corresponding fields of the asset record 122 (e.g., asset name, serial number, vendor, current firmware version, current memory or processing capability, etc.).

Asset registration component 108 can also record the current location of the asset 304 based on information provided by the wearable appliance 202. In some scenarios, the system 102 can leverage the location and orientation data 312 generated by the wearable appliance 202 to determine the current location of the discovered asset 304. According to an example technique, the wearable appliance 202 can send its visual data and/or smart device data together with its location and orientation data 312, which identifies the current location and orientation of the appliance 202 at the time the visual data or smart device data was collected. The asset identification component 106 can translate the location of the wearable appliance 202 to a location within the plant facility and add this location information to the asset record 122 for the asset 304. In some embodiments, the asset registration component 108 records the location as a set of multidimensional coordinates having a level of granularity sufficient to allow the system's navigation features to guide a user to the location of the asset 304 (as will be described in more detail herein).

The asset registration component 108 can also record the location of the asset 304 as a description of the area or room within the plant facility in which the asset 304 is located. In such embodiments, the asset identification component 106 can determine the area or room in which the asset 304 is located by cross-referencing the wearable appliance's location at the time the asset 304 is discovered (as obtained from the location and orientation data) with a plant model 504 that defines the various rooms or areas of the plant facility in terms of their geographical coordinates. Based on information about the facility's layout contained in the plant model 504, the asset identification component 106 can translate the wearable appliance's location to an alphanumeric description of the area or room in which the discovered asset 304 is located. In some embodiments, the asset identification component 106 can generate more precise location information for the asset 304 based on the current orientation of the wearable appliance 202 (as obtained from the location and orientation data 312) at the time the visual data 308 for the asset 304 was collected, as well as the location of the asset 304 within the user's field of view at the time of collection. Asset identification component 106 can use this information to determine, for example, a section of a room in which the asset 304 currently resides, a specific shelf on which the asset 304 is stored, or other such location information. Asset registration component 108 can then include this information in the asset record 122 for the asset 304.

Some items of data included in the asset record 122, including some of the data fields defined by the asset templates 502, can be populated with information submitted by the user via speech or gestures captured by the wearable appliance 202. For example, as part of the asset registration process, the client interface component 104 can render, on wearable appliance 202, indications of data fields that cannot be automatically populated and that require human-entered information. These data fields can be rendered as AR overlays within the user's field of view, and can be individually selected using appropriate gestures (recorded by the wearable appliance 202 as gesture data 510). Once a data field is selected, the user can speak the information to be entered into the selected field. The wearable appliance 202 will record the user's speech as speech data 512 and send this data 512 to the asset management system 102. Upon receipt of the field selection and associated speech data 512, the asset registration component 108 translates the speech data 512 to alphanumeric text representing the user's spoken information and populates the selected field with the text. For data fields that are a binary data type (e.g., checkbox selections) or that offer a selection from among multiple predefined choices (e.g., a classification or category of the asset 304), the user can set values of those fields using appropriate gesture actions recorded by the wearable appliance 202 as gesture data 510. Some fields may also be populated using data from other external sources, including information obtained from a database that stores relevant information about the asset being registered.

Some embodiments can also allow the user to submit a photographic image of the asset being registered for storage as part of the asset record 122. The image can be obtained by the wearable appliance 202 and submitted as an image file, which can then be added to the record 122 by the asset registration component 108.

In some embodiments, the asset management system 102 can customize the user's ability to register assets based on the user's role or identity. In such embodiments, a user profile can be defined for each authorized user of the system 102 indicating the user's role or the scope of asset management features that are granted to the user. The system 102 can use any suitable technique to determine the user's identity or role, including but not limited to collection of biometric data using the wearable appliance 202 (e.g., a retina scan, voice recognition, facial scan, or another biometric indicator). User profiles can specify, for example, the types of assets 304 that the user is permitted to register (e.g., office supplies, maintenance tools and equipment, spare parts for industrial machines, etc.), which types of assets 304 the user is permitted to check out from their home locations, or other such permissives.

When data entry for an asset record 122 is complete—e.g., in response to a gesture or spoken command indicating that the user has finalized and approved the content of the record 122—the asset registration component 108 stores the asset record 122 as part of the asset inventory data for the facility. The asset registration component 108 can also assign a time and date stamp to the record 122 reflecting the time that the record was created or updated.

The techniques described above for discovering and registering assets 304 within an industrial facility can be performed in either an active manner, whereby the user 508 actively seeks and scans assets 304 for registration in the asset management system 102, or passively by the wearable appliance 202 as the user 508 is traversing the plant and performing other tasks. In the passive scenario, the wearable appliance 202 can continuously scan the user's surroundings-including collecting visual data 208 of the surroundings and polling smart devices that may contain smart device data 306—as a background process while the user is engaged in other tasks, and submit this information to the system 102. The system 102 can analyze this passively collected information as described above to identify any assets 304 that may be recognizable within the submitted data and to generate or update appropriate asset records 122 accordingly.

In some embodiments, the asset management system 102 can enhance the accuracy of asset record generating using artificial intelligence (AI) self-learning. For example, the AR-assisted information received from the wearable appliance 202 can be provided to an AI self-learning system, which can use the scanned information to train learning models over time to accurately identify assets and their locations.

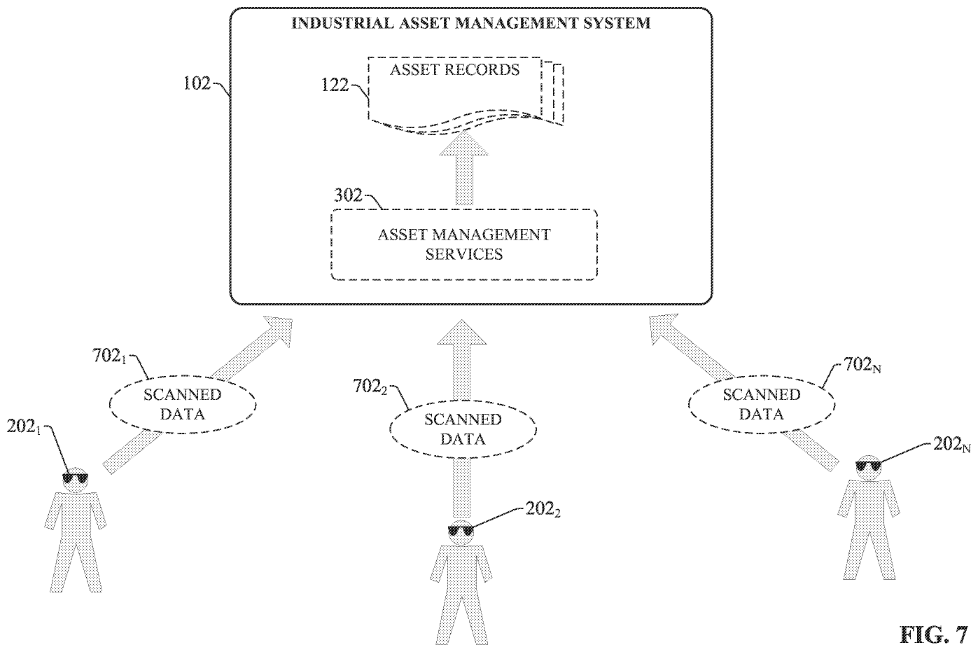

The approach described above for discovering and registering assets 304 can be implemented using multiple AR-capable wearable appliances 202 used by multiple users within the industrial facility, all of which can interface with the asset management system's client interface component 104 and provide AR-assisted data. In this way, the system 102 supports a crowdsourcing approach to maintaining accurate asset management information. FIG. 7 is a diagram illustrating creation and management of asset records 122 based on scanned data 702 received from multiple wearable appliances 202. In this example, each of multiple wearable appliances 202₁-202_{N} can collect and submit scanned data 702₁-702_{N} (any of the types of AR-assisted data described above in connection with FIGS. 3-6) to the asset management system 102, which generates or updates the asset records 122 based on analysis of this data 702 as described above. The multiple wearable appliances 202 can submit both actively and passively collected data 702 as their corresponding users traverse the plant facility, providing multiple streams of data 702 that can be mined by the asset management services 302 (implemented by the asset identification component 106 and asset registration component 108) for updated asset information. As noted above, asset data 702 can be collected and submitted by the wearable appliances 202 as background processes while those appliances 202 are performing other primary tasks.

Once an asset record 122 has been created and stored for a given asset 304, the asset management system 102 can update this record 122 as needed when subsequent information about the asset 304 is received from any of the multiple wearable appliances 202 in use within the facility. For example, if the asset identification component 106 determines that visual data 308 or smart device data 306 received from a wearable appliance 202 contains information about a registered asset 304—such as a tool used by maintenance staff—and that the location and orientation data 312 submitted with this new information corresponds to a different location than that which is indicated in the asset's record 122, the asset registration component 108 will update the asset record 122 for the asset to record the new current location for the asset. This approach can ensure that the current locations of a plant's various assets are kept up to date, and can also be used to assist in locating missing assets, particularly when asset data is actively and passively crowdsourced by multiple wearable appliances 202 throughout the facility. Other asset attributes can also be updated in this manner, including but not limited to a status of the asset (e.g., the asset's current memory or processing capacity, the asset's current power level, etc.). The multiple wearable appliances 202 can continuously scan the working environment within the plant facility to maintain accurate records of assets' locations and statuses.

In some embodiments, the asset management system 102 can consider the number of different wearable appliances 202 that have confirmed an identity, location, or status of a specific asset in connection with updating the asset record 122 for that asset. This feature can be useful in scenarios in which multiple wearable appliances 202 report conflicting information for the same asset. In such scenarios, the asset registration component 108 can update the asset's record 122 to reflect the version of the conflicting information that was reported by the greatest number of wearable appliances 202.

Although the examples described herein have depicted wearable AR appliances 202 or other AR client devices as the sources of asset tracking information, other types of mobile devices or systems can also be configured to scan their environment and provide information to the system 102 that can be used to identify and track assets and their locations and statuses. For example, remote controlled or autonomous drones or automated guided vehicles (AGVs) can be configured to perform similar types of environment scans and smart device queries as those performed by the wearable appliances 202 described above, and to provide this information to the asset management system 102 via remote connection to the client interface component 104. Other types of devices that can serve as sources of asset tracking information include, but are not limited to, cameras (both 2D image cameras as well as 3D or time-of-flight cameras), weight sensors, light curtains, or other such devices capable of providing information from which the presence or identities of assets can be determined or inferred. These alternative sources of asset data can be used in conjunction with, or as an alternative to, the AR devices described herein.

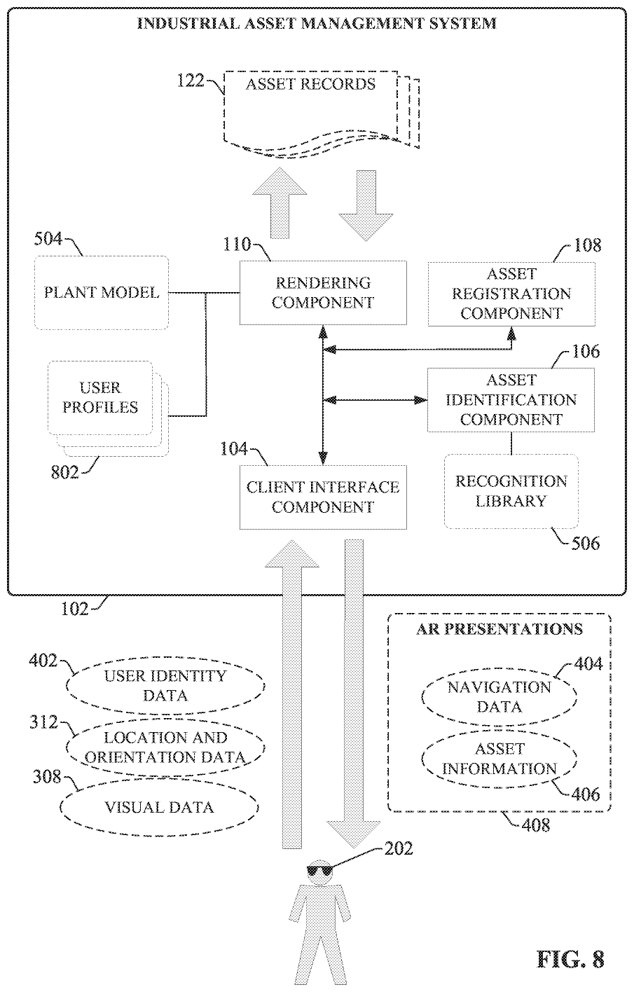

Once a set of asset records 122 have been registered, asset management system 102 can interact with wearable appliances 202 within the plant facility to provide various AR-assisted asset management services, including AR-assisted asset check-in and check-out procedures, navigation guidance, informational presentations, or other such asset management services. FIG. 8 is a diagram illustrating generation and delivery of AR presentations 408 by the asset management system 102. In general, system 102 can render custom AR presentations 408 on a wearable appliance 202, leveraging the data contained in the registered asset records 122 as needed, to visualize asset information, guide a user to the location of a desired or missing asset, assist in the organization of assets according to asset classifications, and other such asset management functions.

Depending on the type of asset management function being performed, the asset management system's rendering component 110 can set the content and format of an AR presentation 408 based on various types of information provided by the wearable appliance 202, including but not limited to the user's identity or role (as determined based on user identity data 402), the location and orientation data 312 representing the wearable appliance's current location and orientation, and visual data 308 generated based on a scan of the user's surroundings.

In an example scenario, a user may wish to locate an asset 304 of interest, or a missing asset 304 whose current location is not known to the user. Asset management system 102 can use information contained in the asset records 122—including an asset's known current location as previously reported by one or more wearable appliances 202—in conjunction with the location and orientation data 312 generated by the user's wearable appliance 202 to generate AR presentations 408 containing visual, audio, or haptic cues designed to guide the user to the asset 304. To initiate the navigation process, the user can identify the asset 304 to be located using any suitable interaction with the asset management system 102. For example, the user may speak the identity of the asset 304 to be located, and wearable appliance 202 can submit a recording of the spoken asset identifier to the system 102 as speech data 512 which can be translated by the asset identification component 106. In another example, the user can browse a list of registered assets 304 rendered by the client interface component 104 as an AR presentation 408 and select the asset of interest using a gesture-based interaction with the presentation 408. In still another example, the system 102 can infer that a current task being performed by the user—e.g., a maintenance task in which the user is attempting to repair a machine or device—requires a certain tool or part that is not currently in the user's possession (e.g., a replacement part, a socket of a size required to detach a nut on the machine or device, etc.). Based on this inference, the system 102 can render a notification on the user's appliance 202 identifying the required tool or part and initiate the process of guiding the user to this required asset.

The user may indicate a desire to locate a specific asset 304 or, alternatively, may indicate a desire to locate any instance of a specified asset type of which multiple instances are available (e.g., an instance of a tool or a spare part required to perform a maintenance task, if multiple instances are available within the facility). In the latter case, the rendering component 110 can identify an accessible instance of the desired asset type having a location that is nearest to the user's current location, as determined based on a comparison between the location and orientation data 312 and the locations of each available instance of the asset type recorded in the asset records 122. In some embodiments, if an accessible instance of the desired asset type is not available, the system 102 can render a notification on the user's appliance 202 recommending that a purchase order be generated for the asset, or informing the user of the nearest vendor having the asset in stock and available for purchase.

With the asset 304 of interest known, the rendering component 110 can reference the asset record 122 corresponding to the selected asset 304 to determine the asset's current location, and compare this current asset location with the user's current location and direction of view, as determined from the location and orientation data 312 submitted by the wearable appliance 202. Based on this comparison, the rendering component 110 can determine the location of the asset 304 relative to the user's current location, and render an AR presentation 408 that displays or otherwise conveys navigational instructions for traversing a route from the user's current location to the asset's location based on the relative location. The navigational instructions can be rendered on the wearable appliance 202 as one or both of alphanumeric text or graphical indicators the indicate a direction travel relative to the user's current location and line of sight.

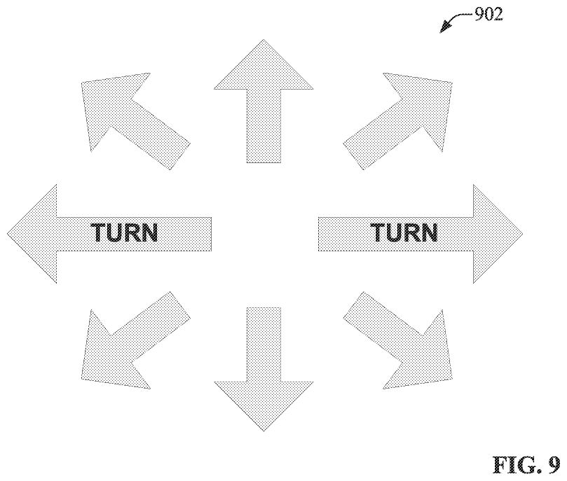

For example, if the asset 304 is currently outside of the user's visual range, as in a scenario in which the asset 304 currently resides in a different area of the facility than the area in which the user is currently standing, the rendering component 110 can instruct the wearable appliance 202 to render a graphical arrow, overlayed onto the user's field of view, pointing in a direction in which the user should begin traveling. FIG. 9 is a set of example arrow graphics 902 that can be rendered on the user's wearable appliance 202 in connection with guiding the user along a route to the asset 304 of interest. The arrow's direction and the location of the arrow within the user's field of view is a function of the user's current location relative to the current location of the asset 304, as well as the user's current direction of view (where the user's field of view is determined based on the orientation of the wearable appliance 202 as reported by the location and orientation data 312). The arrow's direction and location may also be a function of the visual data 308 representing the spatial topography of the user's current field of view, from which the rendering component 110 can infer the presence of wall, objects, or doors within the user's field of view. The rendering component 110 can use this information to position and orient the navigational graphics within the user's field of view to guide the user around obstacles or through indicated doors that are along the route to the asset.

In addition to graphical indicators such the arrows depicted in FIG. 9, the rendering component 110 can also render alphanumeric navigation instructions or other text-based information as part of the AR presentation 408. This information can include, for example, instructions indicating which direction the user should turn, an identity of the room in which the asset 304 is located, an identifier of a shelf on which the asset 304 resides (as determined from the asset record 122), or other such information. Depending on the capabilities of the wearable appliance 202, the rendering component 110 can also initiate other types of guidance feedback via appliance 202, including but not limited to audio signaling (e.g., automated voice guidance, spatial audio that indicate a direction based on which ear receives the sound and that indicate a direction using volume control, etc.) and haptic signaling (e.g., physical tapping that indicates a direction based on which shoulder is subjected to the tap).

Returning to FIG. 8, some embodiments of the rendering component 110 can determine the appropriate content and placement of navigational graphics (such as those depicted in FIG. 9 and other navigational AR content to be described below) based on any combination of the location and orientation data 312 received from the wearable appliance 202, visual data 308 (e.g., spatial mesh data) received from the wearable appliance 202, and the plant model 504 that defines the layout of the plant facility in terms of the rooms, areas, walls, doors, or other layout features of the facility. For example, when the asset's location is determined from the corresponding asset record 122, the rendering component 110 can cross-reference this location with the plant model 504 to determine the name of the room or area corresponding to the asset location, and render this name as part of the AR presentation 408. The rendering component 110 can also use the wearable appliance's location and orientation to infer the user's field of view, and cross-reference this information with the plant model 504 as needed to infer any structural features—e.g., walls, doors, corridors, stairs, shelves, etc.—that are expected to be in the user's current field of view. This information can then be used to correctly locate and orient navigational graphics within the user's field of view such that the graphics are placed on or near structural features being indicated by the graphics (e.g., doors, steps, shelves, etc.).

The rendering component 110 can further refine the placement of navigational graphics by referencing visual data 308 received from the wearable appliance 202, which can provide explicit information about the structures within the user's field of view. In an example scenario, the rendering component 110 can determine the room or area in which the user is currently standing based on the location and orientation data 312 and the plant model 504, and based on this information can infer the identities of objects or structures identified in the visual data 308. By combining these different types of information, the rendering component 110 can accurately locate and orient navigational graphics within the AR presentation 408 such that the graphics are associated or aligned with the correct objects or structure.

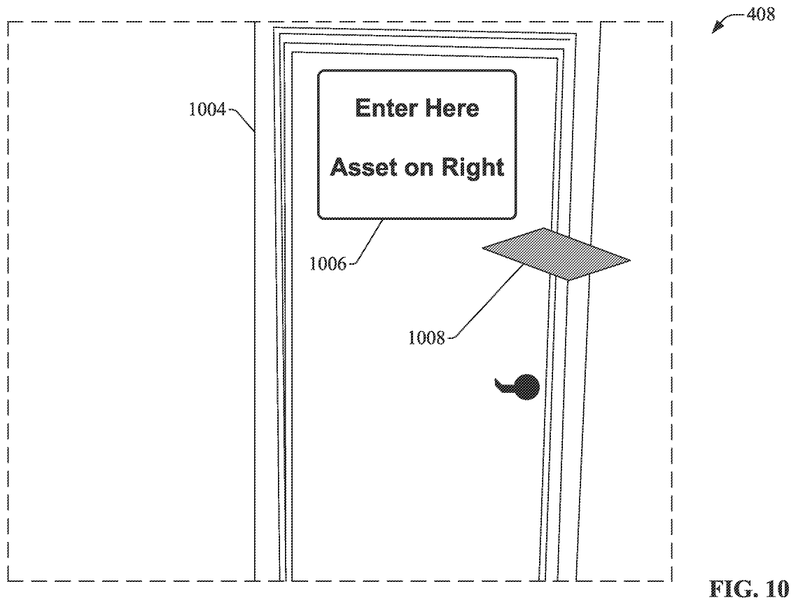

As the user moves closer to the location of the asset 304, rendering component 110 can render other types of AR graphics on the wearable appliance 202 to direct the user to the asset 304. FIG. 10 is an example portion of an AR presentation 408 that can be rendered on the wearable appliance 202 in a scenario in which the user is standing outside of a room in which an asset 304 of interest is located. In this example, the asset 304 resides on a shelve within a room that is accessed via a door 1004. The AR presentation 408 has guided the user to the room's entrance using the graphical navigation features discussed above, and the user is currently viewing the door 1004 through the wearable appliance 202 (or another AR-capable device in communication with asset management system 102). The door 1004 and surrounding wall are physical elements being viewed by the user via the wearable appliance 202, and graphics 1006 and 1008 are graphical AR elements that are rendered over the user's field of view by the rendering component 110. The rendering component 110 can render a graphic 1006 onto the user's field of view, on or near the door 1004, indicating the door 1004 as the entrance to the room in which the asset 304 is located. The graphic 1006 can include alphanumeric text instructing the user to enter through the door 1004, as well as more detailed information informing the user where, within the room, the asset 304 is located (e.g., “Asset on Right”).

In some embodiments, the rendering component 110 can also render a graphic 1008 on the user's field of view over the asset 304 when the asset is within visual range of the user. This graphic 1008 can be rendered even if there is a visual barrier between the user and the asset 304, such as a wall or door. In the example depicted in FIG. 10, the graphic 1008 comprises a square that is placed at a location within the AR presentation 408 corresponding to the location of the asset 304 within the user's field of view. Since the door 1004 and surrounding wall are between the user and the asset, the graphic 1008 is rendered over the door 1004 and wall at the location of the user's field of view at which the asset would be seen if the door 1004 and wall were absent, effectively providing an X-ray view of the asset 304 through the door 1004 and wall.

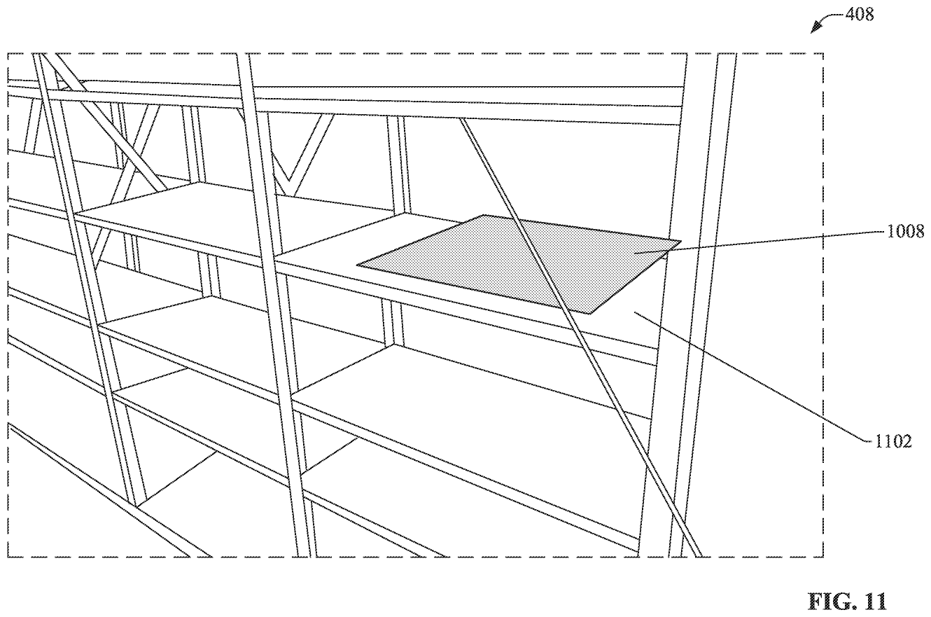

FIG. 11 is an example portion of an AR presentation 408 that can be rendered on the wearable appliance 202 once the user has passed through the door 1004 and entered the room in which the asset resides. In this example, the asset is stored on a shelf 1102 within the room. The shelf 1102 and its associated structural elements are physical elements being viewed by the user via the wearable appliance 202. Graphic 1008 continues to be overlaid at the location of the user's field of view corresponding to the location of the asset. Since no visual obstructions block the user's view of the asset, the graphic 1008 is overlaid on the asset to direct the user's attention to the asset.

The system 102 can use similar AR-based guidance to direct a user to the correct home location at which to store a discovered asset 304. This may be useful in scenarios in which the user has discovered a tool or another mobile asset that is not in its correct home location (that is, the location at which the asset should be stored when not in use). In such scenarios, the user can scan or query the discovered asset 304 using wearable appliance 202, and the asset identification component 106 can identify the asset or the type of the asset using any of the techniques described above. Based on the identity of the asset or its type, the rendering component 110 can reference the corresponding asset record 122 to determine the correct home location for the asset 304, and render a suitable AR presentation 408 that guides the user to this home location (similar to the AR presentations 408 described above for guiding the user to an asset location). If the home location is a designated shelf location or drawer, as in the example depicted in FIG. 11, the AR presentation 408 can render a graphic similar to graphic 1008 indicating the correct shelf or drawer. If the discovered asset 304 is currently checked out by another user—e.g., if another user had checked out the asset 304 but failed to return it to its home location or check it back in—the AR presentation 408 can also render the identity and contact information of the person who had checked out the asset 304.

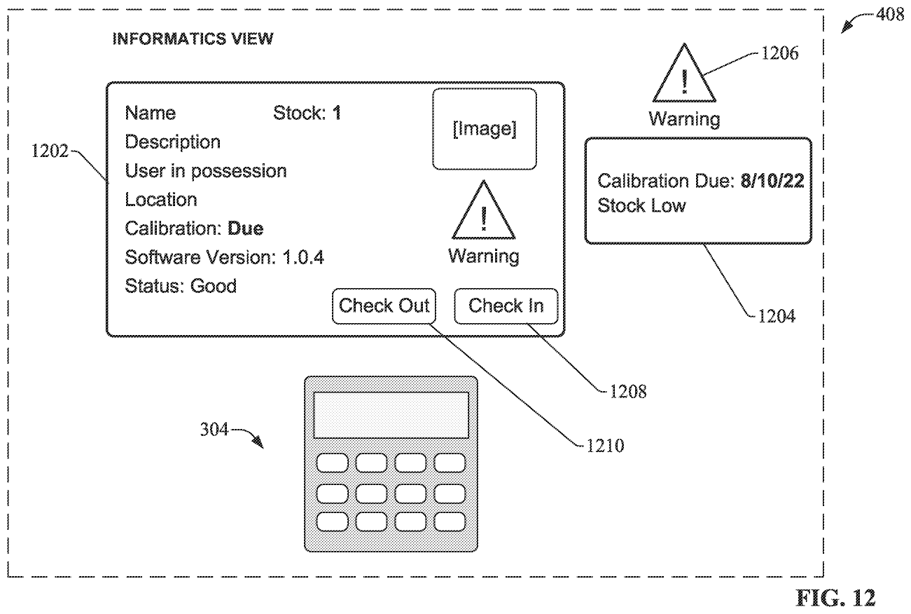

Some embodiments of the asset management system 102 can also leverage the asset records 122 to render an informatics view on a wearable appliance 202 for an asset that is within the user's field of view. FIG. 12 is an example portion of an AR presentation 408 displaying an example informatics view of an asset 304 that can be rendered on the wearable appliance 202. The user can invoke the informatics view using any suitable technique, including but not limited to a gesture or spoken phrase recognized by the wearable appliances 202 as a request to render the informatics view, a recognized context in which informatics information may be useful (e.g., a particular location of the user, an authorization, a task currently being performed by the user, an inferred interest of the user in an asset being viewed, etc.), a recognition that the user has looked at an asset 304 for a defined number of seconds (as determined based on an eye scan), etc. In other embodiments, the system 102 can render the informatics view for an asset 304 in response to a determination that the user has moved within a defined distance from the asset 304 and the asset 304 is within the user's field of view. When the informatics view is requested, the asset identification component 106 can identify an asset 304 or asset type within the user's field of view using any of the asset identification approaches described above, and the rendering component 110 can render, near the asset 304 within the user's field of view, an overlayed informatics window 1202 containing selected items of asset information retrieved from the asset record 122 corresponding to the asset record 122 or asset type.

Example information that can be rendered on the informatics window 1202 can include, for example, a name and description of the asset 304, an identity of a user who is currently in possession of the asset 304 (as recorded using the check in and check out procedure to be described in more detail below), the home location for the asset 304, a stock image for the asset 304, a software or firmware version currently installed on the asset 304, status information for the asset 304 (such as an indication of whether calibration is due, an available memory or processing capacity, etc.), whether any alarms or warnings have been registered for the asset 304, a warranty status for the asset 304, or other such information. If the asset 304 is a heavy but movable item, the informatics window 1202 can include lifting instructions conveying a method for safety moving the asset (e.g., recommending a minimum of two people to move the asset, indicating recommended hand-hold locations when moving the asset, etc.).

In the case of an asset type of which multiple instances are maintained in stock, such as a particular type of spare part, the informatics window 1202 can also specify the number of instances of the viewed asset 304 that are currently in stock. The rendering component 110 can determine the number of instances or items of the viewed asset 304 that are currently in stock based on the number of asset records 122 that correspond to the asset type, or by referencing a separately maintained inventory database. In a related feature, some embodiments of the asset management system 102 can support an AR-assisted part or asset reorder workflow, such that a user can initiate an order for an asset 304 whose stock is low via interaction with a suitable AR presentation 408. In such embodiments, the system 102 can regulate users' ability to initiate an order for additional units of an asset based on user role. In some scenarios, parts can be ordered during a repair or maintenance procedure via interaction with an informatics window 1202, which can also be used to invoke and display relevant documents or procedures that may assist the user in completing the repair procedure.

Some informatics views may render a separate notification window 1204 that displays notification information relating to the asset 304 being viewed. These notifications can include, for example, an impending date on which calibration of the asset 304 is due, an indication that the number of units of the viewed asset 304 is lower than the defined minimum number of units that should be maintained in inventory, or other such notification. The informatics view can also render warning or alarm symbols 1206 if the viewed asset 304 is currently subject to a warning or alarm.

As noted above, some assets 304 may have designated home locations at which those assets should be stored when not being used. These may include, for example, tools or equipment used by maintenance staff or portable devices that are shared by multiple staff members. In some embodiments, the asset management system 102 can support an AR-assisted check in and check out procedure that tracks mobile assets' usage status and location. According to an example workflow, the informatics view, or another AR presentation 408 dedicated to asset check in/check out, can render interactive controls—such as Check Out control 1210 and Check In control 1208—that allow a user to indicate to the system 102 that he or she is checking in or checking out an asset. Typically, the asset 304 is defined to be checked in while not in use and residing at its home location. Users wishing to use the asset 304 are required to formally check the asset 304 using the Check Out control 1210, which can be selected via a suitable user action (e.g., a gesture or spoken command recognized by the wearable appliance 202). When the Check Out control 1210 is selected, the asset registration component 108 can update the asset record 122 for the asset 304 to change the asset's status from Checked In to Checked out, to record the time and date that the asset was checked out, and to record the identity of the user who has checked out the asset (as obtained from the user identity data 402 provided by the wearable appliance 202). The user may then remove the asset 304 from its home location for use. As an alternative to the Check Out control 1210 and Check In control 1208, the check out procedure can be automated, such that system 102 automatically sets an asset's status as being checked out when the asset is moved from its home location, and sets that asset's status as being checked in when the asset is returned to its home location. In one or both cases, the system can generate and deliver notifications to appropriate personnel in response to detecting that an asset has been check in or check out.

In some embodiments, the ability to check out an asset 304 can be regulated as a function of the users' identities or roles, as defined by the user profiles 802. In this regard, different classifications of assets 304 may be assigned different check out permissives, such that only a specified subset of users or user roles may check out a given type of asset. For example, check out permissives can be defined specifying that tools or equipment used by the plant's maintenance staff may only be checked out by users whose user profiles 802 indicate a maintenance role. If a user attempts to check out an asset 304 that the user is not permitted to check out (as determined based on the user's identity or role, as well as the check out permissives defined for the asset 304), the asset registration component 108 can change the asset's status to Misplaced rather than Checked Out, and record the identity of the user in the asset record 122 corresponding to the asset 304. In some embodiments, removal of an asset from its home location by a user who either has not first formally checked out the asset (e.g., using Check Out control 1210) or is not a member of the correct user role will cause the client interface component 104 to send a notification to one or more supervisory employees identifying the asset 304 that has been improperly removed from its home location.

While the asset 304 is checked out, the asset management system 102 can track the asset's location using the techniques described above, including crowdsourcing of the asset's location based on information received from the wearable appliance 202 of the user who checked out the asset as well as other sensing devices located throughout the plant facility that are capable of detecting the asset, such as appliances 202 of other employees who are within scanning range of the asset 304, fixed sensors, drones, AGV-mounted sensors, or other such devices.

In some embodiments, geographic boundaries or areas may be defined for a given asset. These boundaries can specify exclusive areas or perimeters within which the asset may be used. While such an asset is checked out, the system 102 compare the asset's current location with the defined boundaries or areas of permitted use. If the asset is moved outside the permitted areas assigned to that asset, the system 102 can deliver a notification indicating that the asset has been moved outside of its permitted usage area to one or more appropriate device (e.g., the appliance 202 of the user to whom the asset is currently checked out, a client device of a maintenance supervisor, etc.).

When the user is finished using the asset 304, the user can formally check the asset 304 back in by returning the asset 304 to its home location, invoking the Check In and Check Out AR controls, and selecting the Check In control 1208. In response to selection of the Check In control 1208, the asset registration component 108 can determine whether the asset 304 is in its correct home location and, if so, update the asset's record 122 to change the asset's status to Checked In. In some embodiments, the asset registration component 108 can also generate a record of the asset's check out duration, including the identity of the user who had checked out the asset 304 and the date, time, and duration of the check out period. This AR-assisted workflow for checking out and checking in mobile assets is less time consuming and less prone to manual entry errors relative to a manual check-out procedure. As noted above, some embodiments may automate the check in procedure but automatically setting the asset's status as being Checked In when the asset is returned to its home location.

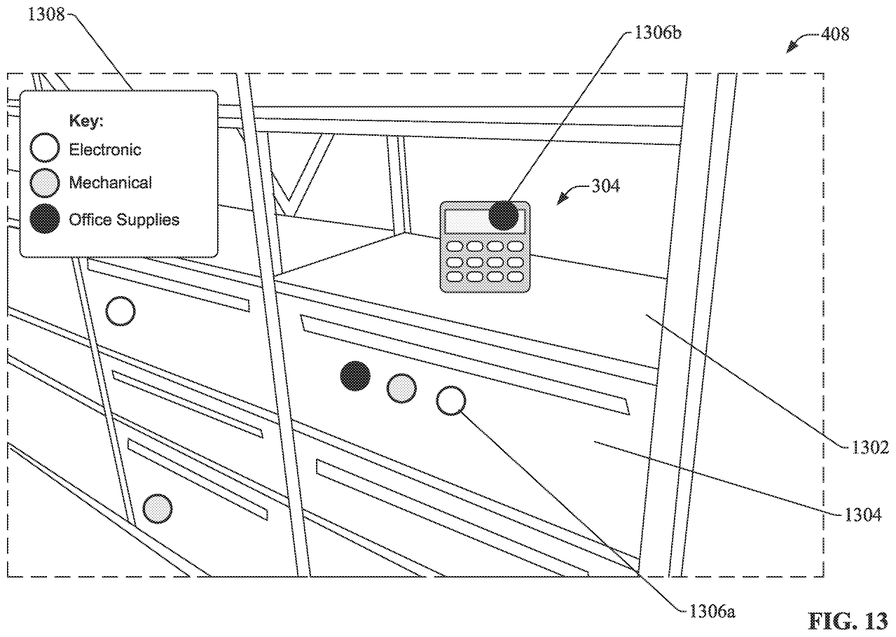

Some embodiments of asset management system 102 can also leverage the asset records 122 and AR data received from the wearable appliances 202 to assist with organizing assets according to asset categories. FIG. 13 is an example portion of an AR presentation 408 that renders color-coded asset category indicators 1306 designed to assist with location and organization of assets 304. System 102 can support categorization of assets 304 according to multiple defined categories. In the illustrated example, these categories include electronic assets (e.g., industrial controllers, I/O modules, motor drives, network infrastructure devices such as routers, oscilloscopes, telemetry devices, meters, sensors, or other such electronic equipment), mechanical assets (e.g., replacement parts for industrial machines, machining tools, maintenance tools, or other such mechanical equipment), and office supplies (e.g., desktop or laptop computers, calculators, office furniture, stationary supplies, etc.). Other asset categories are also within the scope of this disclosure.

In response to a command from the user (e.g., a recognizable gesture or spoken command), the rendering component 110 can initiate an asset categorization viewing mode. While in this mode, the AR presentation 408 labels assets 304 that are within the user's range of vision-including assets 304 that are hidden by visual obstructions between the user and the asset 304—with asset category indicators 1306 that are color-coded based on the category or classification to which the assets belong. In the example scenario depicted in FIG. 13, the user is viewing a shelf structure via the wearable appliance 202. The shelf structure comprises both open shelves 1302 and drawers 1304 for storage of assets 304. Rendering component 110 can use any of the data processing techniques discussed above-including analysis of asset records 122, location and orientation data 312, visual data 308, or smart device data 306—to determine the locations and identities of assets 304 within the user's current field of view, and can further determine the category of each asset 304 based on information contained in the asset's record 122. With the location and category of each asset 304 known, the rendering component 110 overlays an indicator 1306 at a location within the user's field of view that places the indicator 1306 on or near the asset 304, and sets the color of the indicator 1306 based on the category of the associated asset 304. In the illustrated example, electronic assets are labeled with an indicator 1306 of a first color, mechanical assets are labeled with an indicator 1306 of a second color, and office supplies are labeled with an indicator 1306 of a third color. To assist the user in translating the indicators 1306, the rendering component 110 can also render an overlayed key window 1308 that lists the asset categories and their associated indicator colors.

In addition to helping users to locate assets 304 of specific types, the color-coded indicators 1306 can also assist in organizing assets 304 according to their classifications. In an example scenario, a user may view the contents of a room or shelf while the wearable appliance 202 is rendering an AR presentation 408 in asset categorization viewing mode. The user may wish to organize assets 304 within the room such that assets 304 are physically grouped according to their categories. Using the asset categorization viewing mode, the user can easily distinguish assets 304 according to their category, and relocate assets 304 such that indicators 1306 of like colors are grouped together.

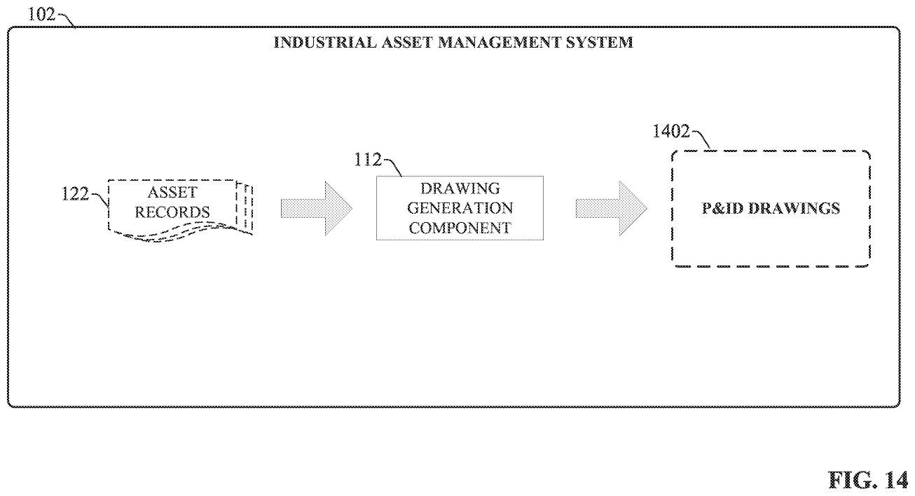

In addition to the asset management functions described above, some embodiments of asset management system 102 can leverage the AR-assisted asset discovery techniques described above to generate or update piping and instrumentation diagram (P&ID) drawings or other types of engineering drawings. FIG. 14 is a diagram illustrating generation of P&ID drawings 1402 for an industrial facility based on information extracted from the asset records 122 generated as described above. Since the AR-assisted asset management functions supported by the system 102 can maintain an accurate inventory of the assets within an industrial facility—including motors, values, instruments, or other aspects of an industrial system—the system's drawing generation component 112 can reference the asset records 122 containing this information to generate P&ID drawings 1402 representing a process system on the plant floor. According to an example workflow, the drawing generation component 112 can reference the asset records 122 to identify a subset of the recorded assets 304 that are relevant to a given automation or process system for which a P&ID drawing 1402 is to be generated or updated, as well as the locations of these assets within the facility. The drawing generation component 112 may also infer piping connections between components of the system from the asset records 122. Based on this information, the drawing generation component 112 generates P&ID drawings 1402 that include symbolic representations of the discovered assets and the connections therebetween. In this way, the system 102 uses AR-based asset discovery to streamline and substantially automate the creation of P&ID drawings 1402, as well as to continuously update these drawings 1402 as new information about the assets is discovered.

Although certain asset management functions described herein have been ascribed to the asset management system 102—including functionalities of component 104, 106, 108, 110, and 112—some or all of the functions ascribed to those components can be implemented on the wearable appliance 202 itself rather than the asset management system 102. For example, in some embodiments the wearable appliance can analyze its own collected visual data 308, location and orientation data 312, smart device data 306, speech data 512, gesture data 510, and user identity data 402 to identify assets 304 and generate corresponding asset records 122, as an alternative to sending this AR-assisted information to a separate asset management system 102 for analysis.

The inventory management system described herein can streamline and substantially automate the process of maintaining an accurate inventory of assets within an industrial facility using both actively and passively collected AR-assisted information. By leveraging AR information to automatically populate data records for a facility's assets, the system can save time and reduce human-entry errors relative to manual creation of inventory records. This approach also results in higher fidelity details regarding inventory status, which can lead to more efficient asset re-ordering procedures and greater accuracy of annual audits. The asset management system can also be integrated with other systems that can benefit from accurate and up-to-date inventory information, such as work order management systems. The system can provide further asset management features by generating AR presentations that visualize, or otherwise convey, intuitive information about assets of interest obtained from the asset inventory records, and that use AR-based navigation to guide users to the locations of specific assets of interest or to instruct users of the correct home location for an asset.

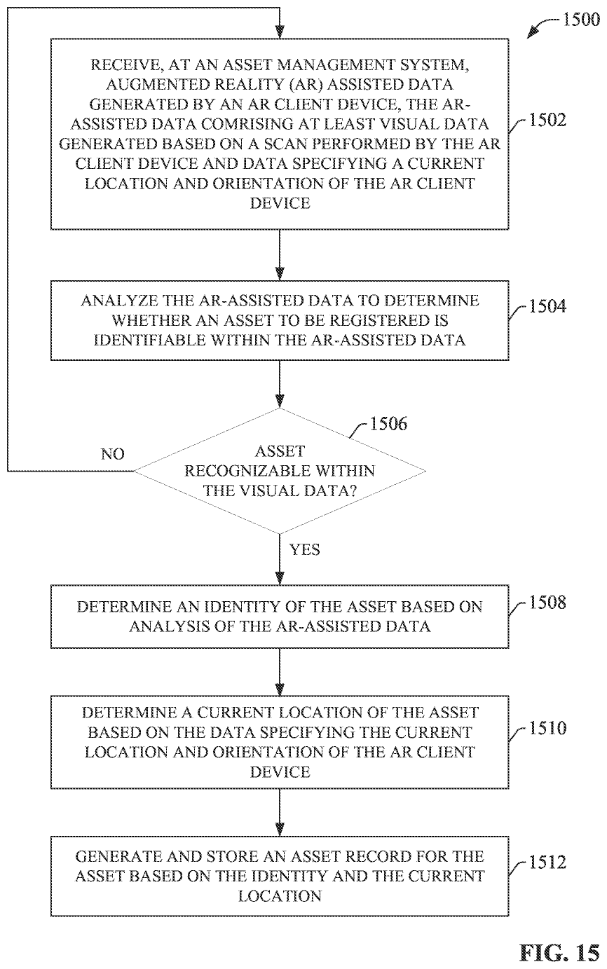

FIGS. 15-17 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 15 is an example methodology 1500 for registering or updating an asset record for an industrial or office asset using AR-assisted techniques. Initially, at 1502, AR-assisted data generated by an AR client device—such as a wearable appliance or other type of AR capable device—is received at an asset management system. The AR-assisted data can comprise at least visual data generated based on a scan performed by the AR client device (e.g., spatial mesh data, optical data, video or photographic data, or other such data) as well as data specifying the current location and orientation of the AR client device. Other types of data can also be received from the AR client device, including but not limited to device data read from smart devices by the AR client device, speech or gesture data representing spoken commands or manual gestures performed by a user of the AR client device, or other such data. In some embodiments, submission of AR-assisted data can be contingent on verification that the user of the AR client device is an authorized user of the asset management system. In some cases, this verification can be achieved using biometric analysis (e.g., a retinal scan, voice recognition, etc.). Also, in some embodiments, collection and submission of the AR-assisted data can be initiated based on a detection of a defined trigger, such as a determination that the user has focused his or her gaze on the asset for a defined period of time (as determined based on an eye or retinal scan).

At 1504, the AR-assisted data received at step 1502 is analyzed to determine whether an asset to be registered is identifiable within the data (e.g., within the visual data or within smart device data if such data was received from the AR client device). In various embodiments, the asset can be recognized based on identification of asset shapes within spatial mesh information generated by the AR client device, optical character recognition analysis performed on an image of a nameplate attached to the asset, explicit asset information contained in smart device data read from a device and conveyed to the asset management system by the AR client device, or other such identification means.

At 1506, a determination is made as to whether an asset to be registered is recognizable within the data based on the analysis performed at step 1504. If no asset is recognized (NO at step 1506), the methodology returns to step 1502. In some cases, if an asset is present but not detected at step 1506, the user may invoke a manual data entry presentation that allows the user to enter information about the asset via manual entry. In addition to registering the unrecognized asset, this manually submitted information can also be used to train the asset management system to recognize the asset in the future. Alternatively, if an asset is recognized (YES at step 1506), the methodology proceeds to step 1508, where an identity of the asset is determined based on analysis of the AR-assisted data. For example, if spatial mesh data is received from the AR client device, the asset can be identified based on a cross-referencing the shape of the asset with information defining shapes that are known to correspond with specific asset types. In another example, the asset can be identified based on explicit data about the asset stored on the asset's memory and read by the AR client device. In still another example, the asset may be identified based on nameplate information or other alphanumeric information printed on the asset and interpreted using optical character recognition. Other approaches for identifying the asset based on analysis of AR-assisted information are also within the scope of one or more embodiments.

At 1510, a current location of the asset is determined based on the data specifying the current location and orientation of the AR client device. In some embodiments, the asset management system can translate the client device's location to an area or room within the plant facility by cross-referencing the client device location with plant map data that defines a layout of the facility in terms of its rooms, areas, doors, and corridors. More detailed location information can also be obtained by synthesizing the location and orientation of the AR client device with the visual data collected by the client device, which can be analyzed to determine a particular storage location (such as a shelf) on which the asset currently resides.

At 1512, an asset record for the discovered asset is generated based on the identity obtained at step 1508 and the current location obtained at step 1510. The asset record can include such information as the identity of the asset, the asset's current location and home location, status information for the asset (e.g., a current memory or processing capacity, a currently installed firmware version, a checked in or checked out status, etc.), or other such information. Methodology 1500 can also be used to update the asset record after the record has been created based on subsequently received AR-assisted data about the asset received from the AR client device or another AR client device. These updates can include, for example, updating the current location of the asset based on discovery of the asset at a new location by the AR client device. In some embodiments, the asset management system can determine whether these updates have been submitted by a user with appropriate authority to access the system. If the user is not authorized, the system can either reject the updates or can update the appropriate asset record while also issuing a notification to a system administrator that a record has been updated by an unauthorized person.

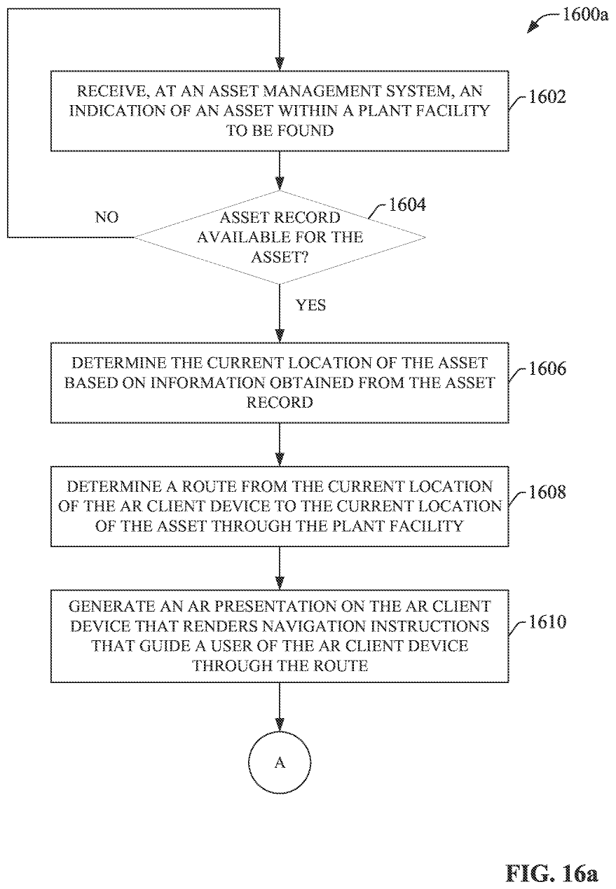

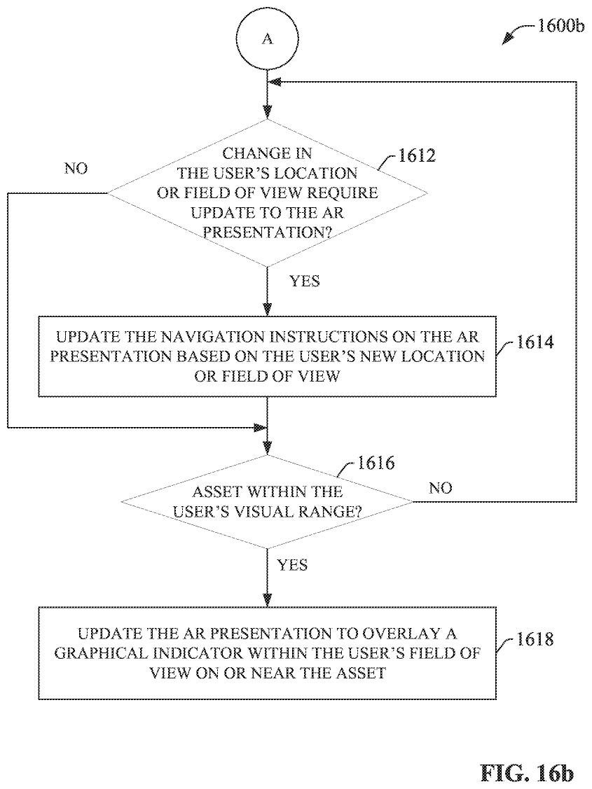

FIG. 16a is a first part of an example methodology 1600a for using augmented reality to guide a user to a desired asset within an industrial facility. Initially, at 1602, an indication of an asset within a plant facility that a user wishes to locate is received at an asset management system. The asset may be, for example, a unit of a spare part, a tool used by maintenance staff, a unit of office equipment, an industrial device or machine, or another type of asset. At 1604, a determination is made as to whether an asset record is available for the asset indicated at step 1602. In this regard, the asset management system may maintain a set of asset records for respective assets within the plant facility, which are created and updated based on AR data received from AR client devices throughout the facility using methodology 1500.

If an asset record for the asset of interest is available (YES at step 1604), the methodology proceeds to step 1606, where the current location of the asset is determined based on information obtained from the asset record. The asset record may record the current location of the asset, as inferred based on a most recent discovery of the asset by an AR client device. The asset record may also indicate whether the asset is currently checked out by, or otherwise in the possession of, another user. If the asset is currently in possession of another user, the system can also send a notification to the other user that the asset is requested. At 1608, a route through the facility from the current location of the AR client device to the current location of the asset (obtained at step 1606) is determined. The current location of the AR client device can be obtained from location and orientation data received from the client device.

At 1610, an AR presentation is generated on the AR client device, where the presentation renders navigation instructions that guide a user of the AR client device through the route determined at step 1608. An example AR presentation may overlay graphical symbols on to the user's field of view to indicate a direction of travel, such as arrows or door indicators. The AR presentation may also display alphanumeric text providing navigational instruction to the user, or may provide audio or haptic signals that direct the user along the route if those types of outputs are supported by the AR client device. The AR presentation may also use audio cues to guide the user to the asset; e.g., by embedding a spatial sound at the asset's location that sonically indicates the asset's location to the user.

The methodology then proceeds to the second part 1600b illustrated in FIG. 16b. At 1612, a determination is made as to whether a change in the AR client device's location nor field of view require an update to the AR presentation. An update may be required, for example, if the user changes the direction of view of the AR presentation or proceeds along the prescribed route to a new location requiring an update of the AR navigational graphics (e.g., an new instruction to proceed to the next stage of the route, or a change in the direction of an arrow graphic in response to a reorientation of the AR client device). If an update to the AR presentation is required (YES at step 1612), the methodology proceeds to step 1614, where the navigation instructions on the AR presentation are updated based on the user's new location or field of view. If an update to the AR presentation is not required (NO at step 1612), step 1614 is skipped.

At 1616, a determination is made as to whether the asset of interest is within the user's visual range 1616. This determination can be made, for example, based on a correlation between the AR client device's current location and orientation and the current location of the asset. If the asset is not within the user's visual range (NO at step 1616), the methodology returns to step 1612 and the user of AR client device continues navigating the route. Alternatively, if the asset is within the user's visual range (YES at step 1616), the methodology proceeds to step 1618, where the AR presentation is updated to overlay a graphical indicator within the user's field of view on or near the asset. The indicator can be placed at the location within the field of view corresponding to the asset even if a visual obstruction exists between AR client device and the asset (e.g., a door or drawer). The placement of the indicator can be set based on the current location and orientation of the AR client device relative to the location of the asset as determined from the asset record, and can also be further refined based on the visual data (e.g., spatial mesh data) generated by the AR client device and representing the objects and surfaces within the current field of view.

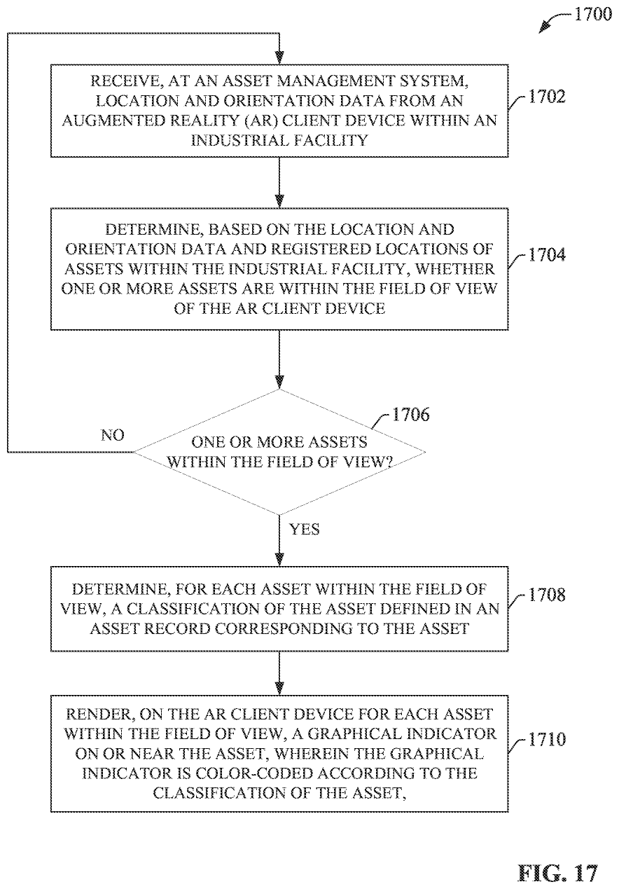

FIG. 17 is an example methodology 1700 for graphically conveying asset classifications via an AR presentation to assist with asset location and organization. Initially, at 1702, location and orientation data is received at an asset management system from an augmented reality client device within an industrial facility. The location and orientation data indicates the current location and direction of view of the AR client device. At 1704, the asset management system determines whether one or more assets are within the field of view of the AR client device based on the location and orientation data received at step 1702, as well as the registered locations of assets within the industrial facility. The current locations of the assets can be stored in asset records for the respective assets, which can be created and maintained using methodology 1500 described above in connection with FIG. 15.

At 1706, if it is determined that there are no assets within the current field of view (NO at step 1706), the methodology returns to step 1702. Alternatively, if one or more assets are determined to be within the current field of view (YES at step 1706), the methodology proceeds to step 1708 where, for each asset within the field of view, a classification of the asset is determined. The asset's classification can be determined by referencing the asset record corresponding to the asset, which defines the classification for that asset. Example asset classifications can include, but are not limited to, electronic assets, mechanical assets, office supplies, or other such classifications.

At 1710, for each asset within the field of view, a graphical indicator is rendered on or near the asset, wherein the graphical indicator is color-coded according to the classification determined at step 1708. In some embodiments, the color of the indicator may also be a function of a current task being performed by the user, such that the color of an indicator conveys a relevance of its corresponding asset to the user's task.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

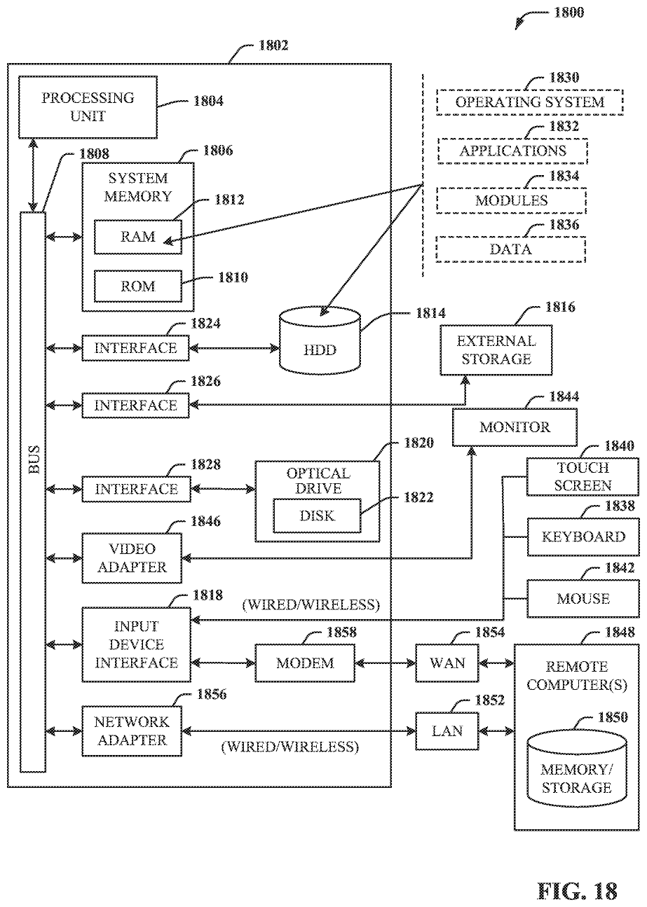

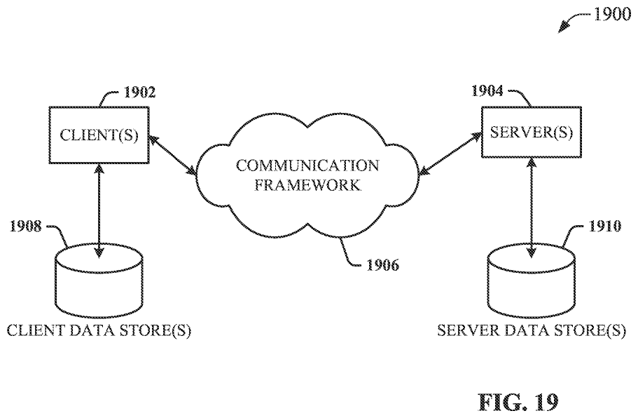

In order to provide a context for the various aspects of the disclosed subject matter, FIGS. 18 and 19 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18 the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for application programs 1832. Runtime environments are consistent execution environments that allow application programs 1832 to run on any operating system that includes the runtime environment. Similarly, operating system 1830 can support containers, and application programs 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1818 that can be coupled to the system bus 1808, but can be connected by other interfaces, such as a parallel port, an IEEE 1394 serial port, a game port, a USB port, an IR interface, a BLUETOOTH® interface, etc.

A monitor 1844 or other type of display device can be also connected to the system bus 1808 via an interface, such as a video adapter 1846. In addition to the monitor 1844, a computer typically includes other peripheral output devices (not shown), such as speakers, printers, etc.

The computer 1802 can operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1852 through a wired and/or wireless communication network interface or adapter 1856. The adapter 1856 can facilitate wired or wireless communication to the LAN 1852, which can also include a wireless access point (AP) disposed thereon for communicating with the adapter 1856 in a wireless mode.

When used in a WAN networking environment, the computer 1802 can include a modem 1858 or can be connected to a communications server on the WAN 1854 via other means for establishing communications over the WAN 1854, such as by way of the Internet. The modem 1858, which can be internal or external and a wired or wireless device, can be connected to the system bus 1808 via the input device interface 1824. In a networked environment, program modules depicted relative to the computer 1802 or portions thereof, can be stored in the remote memory/storage device 1850. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1852 or WAN 1854 e.g., by the adapter 1856 or modem 1858, respectively. Upon connecting the computer 1802 to an associated cloud storage system, the external storage interface 1826 can, with the aid of the adapter 1856 and/or modem 1858, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 1922 is a schematic block diagram of a sample computing environment 1900 with which the disclosed subject matter can interact. The sample computing environment 1900 includes one or more client(s) 1902. The client(s) 1902 can be hardware and/or software (e.g., threads, processes, computing devices). The sample computing environment 1900 also includes one or more server(s) 1904. The server(s) 1904 can also be hardware and/or software (e.g., threads, processes, computing devices). The servers 1904 can house threads to perform transformations by employing one or more embodiments as described herein, for example. One possible communication between a client 1902 and servers 1904 can be in the form of a data packet adapted to be transmitted between two or more computer processes. The sample computing environment 1900 includes a communication framework 1906 that can be employed to facilitate communications between the client(s) 1902 and the server(s) 1904. The client(s) 1902 are operably connected to one or more client data store(s) 1908 that can be employed to store information local to the client(s) 1902. Similarly, the server(s) 1904 are operably connected to one or more server data store(s) 1910 that can be employed to store information local to the servers 1904.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components;
a processor, operatively coupled to the memory, that executes the executable components, the executable components comprising:
a client interface component configured to receive, from an augmented reality (AR) client device within a plant facility, sensor data representing shapes of objects within a field of view of the AR client device, and location and orientation data indicating a current location and orientation of the AR client device;
an asset identification component configured to identify an asset within the field of view of the AR client device based on analysis of the sensor data; and
an asset registration component configured to, in response to identification of the asset by the asset identification component, create or update an asset record for the asset based on the identification of the asset, wherein the asset record records an identity of the asset and a location of the asset based on the location and orientation data.

2. The system of claim 1, wherein the sensor data comprises at least one of spatial mesh data, time-of-flight data, photographic data, video data, audio data, or biometric data.

3. The system of claim 1, wherein the asset determination component is configured to identify the asset based on recognition of a shape defined by the sensor data that corresponds to a known shape of a type of asset.

4. The system of claim 1, wherein the asset is at least one of an industrial device, an industrial controller, an I/O module, a motor drive, a contactor, a human-machine interface terminal, a machine of an industrial automation system, a spare part for the industrial automation system, a tool, a unit of maintenance equipment, a desktop computer, a laptop computer, or an office supply asset.

5. The system of claim 1, wherein
the client interface component is further configured to receive, from the AR client device, smart device data read from a memory of a smart device by the AR client device,
the asset registration component is configured to create or update an asset record for the smart device that includes at least a portion of the smart device data, and
the smart device data comprises at least one of a model number of the smart device, a serial number of the smart device, a vendor of the smart device, a type of the smart device, specification information for the smart device, identities of software installed on the smart device, or a firmware version installed on the smart device.

6. The system of claim 1, wherein the asset registration component is further configured to record, in the asset record, at least one of a home location of the asset, a classification of the asset, a description of the asset, status information for the asset, a number of units of the asset currently in stock, or a functional capability of the asset.

7. The system of claim 1, wherein the asset registration component is further configured to,
in response to determining that the location of the asset does not correspond to a home location designated for the asset, update the asset record to indicate that the asset is checked out, and
in response to determining that the location of the asset corresponds to the home location designated for the asset, update the asset record to indicate that the asset is checked in.

8. The system of claim 1, wherein the asset identification component is configured to determine the location of the asset based on a cross-referencing of the location and orientation data with a plant model that defines a layout of the plant facility.

9. The system of claim 1, wherein the asset registration component is configured to format the asset record based on an asset template that defines data fields of the asset record, and to populate one or more of the data fields using information obtained based on analysis of the sensor data and the location and orientation data.

10. The system of claim 9, wherein the asset registration component is further configured to populate one or more other data fields of the asset record based on speech data received from the AR client device.

11. The system of claim 1, wherein the client interface component is configured to update the asset record based on sensor data and location and orientation data received from multiple client devices within the plant facility, and the multiple client devices comprises at least one of an AR client device, a smart phone, a drone, a camera, an autonomously guided vehicle, a robot, a fixed sensor, or a mobile sensor.

12. A method, comprising:
receiving, by a system comprising a processor from an augmented reality (AR) client device, sensor data representing an area surrounding the AR client device and location and orientation data representing a current location and orientation of the AR client device within an industrial facility;
identifying, by the system based on analysis of the sensor data, an asset within the area surrounding the AR client device; and
in response to the identifying, generating or updating an asset record for the asset,
wherein
the asset record comprises information about the asset determined based on the analysis of the sensor data and the location and orientation data, and
the information comprises at least an identity of the asset and a location of the asset within the industrial facility.

13. The method of claim 12, wherein the sensor data comprises at least one of spatial mesh data, time-of-flight data, photographic data, video data, or audio data.

14. The method of claim 12, wherein the asset is at least one of an industrial device, an industrial controller, an I/O module, a motor drive, a contactor, a human-machine interface terminal, a machine of an industrial automation system, a spare part for the industrial automation system, a tool, a unit of maintenance equipment, a desktop computer, a laptop computer, or an office supply asset.

15. The method of claim 12, further comprising
receiving, by the system from the AR client device, smart device data read from a memory of a smart device by the AR client device or another device; and
in response to the receiving of the smart device data, generating or updating an asset record for the smart device that comprises at least a portion of the smart device data, and
wherein the smart device data comprises at least one of a model number of the smart device, a serial number of the smart device, a vendor of the smart device, a type of the smart device, specification information for the smart device, an identity of software installed on the smart device, or a firmware version installed on the smart device.

16. The method of claim 12, wherein the generating or updating of the asset record comprises recording, in the asset record, at least one of a home location of the asset, a current location of the asset, a classification of the asset, a description of the asset, status information for the asset, a number of units of the asset currently in stock, or a functional capability of the asset.

17. The method of claim 12, further comprising:
cross-referencing the location and orientation data with a plant model that defines a layout of the industrial facility;
determining the location of the asset based on a result of the cross-referencing; and
recording the location in the asset record.

18. The method of claim 12, wherein the generating or updating of the asset record comprises:
formatting the asset record based on an asset template that defines data fields of the asset record, and
populating one or more of the data fields using information obtained based on analysis of the sensor data and the location and orientation data.

19. A non-transitory computer-readable medium having stored thereon instructions that, in response to execution, cause a system comprising a processor to perform operations, the operations comprising:
receiving, from an augmented reality (AR) client device, spatial mesh data generated by the AR client device based on a scan of an area surrounding the AR client device, and location and orientation data representing a current location and orientation of the AR client device within a plant facility;
identifying, by the system based on analysis of the spatial mesh data, an asset within the area surrounding the AR client device; and
in response to the identifying, creating or updating an asset record comprising information about the asset determined based on the analysis of the spatial mesh data and the location and orientation data, wherein the information about the asset comprises at least an identity of the asset and a location of the asset within the plant facility.

20. The non-transitory computer-readable medium of claim 19, wherein the asset is at least one of an industrial device, an industrial controller, an I/O module, a motor drive, a contactor, a human-machine interface terminal, a machine of an industrial automation system, a spare part for the industrial automation system, a tool, a unit of maintenance equipment, a desktop computer, a laptop computer, or an office supply asset.
